(19) United States
(12) Patent Application Publication
(10) Pub. No.: US 2009/0221092 A1
(43) Pub. Date: Sep. 3, 2009

(54) LIDDED MICROCHIP FOR ANALYSIS, SAMPLE PROCESSING METHOD FOR THE LIDDED MICROCHIP, AUTOMATIC SAMPLE PROCESSING METHOD FOR THE LIDDED MICROCHIP, AUTOMATIC SAMPLE PROCESSING APPARATUS BASED ON THE PROCESSING METHOD, AND SUBSTANCE ANALYZING APPARATUS TO WHICH THE AUTOMATIC SAMPLE PROCESSING METHOD IS APPLIED

(75) Inventor: Machiko Fujita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 11/815,934

(22) PCT Filed: Feb. 10, 2006
(86) PCT No.: PCT/JP2006/302333

§ 371 Date: Jan. 14, 2008

(30) Foreign Application Priority Data
Feb. 10, 2005 (JP) 2005-034821
Feb. 3, 2006 (JP) 2006-026889

(51) Int. Cl. G01N 1/28; B01L 11/00

(52) U.S. Cl. 436/177; 422/99; 422/101

(57) ABSTRACT

The present invention provides a method of automating the operation to peel and remove a lid part adhered and fixed to the top surface of a substrate part, which composes a lidded “microchip”, after subjecting a sample liquid to be analyzed to an operation for electrophoretic separation. After subjecting the liquid sample to be analyzed to a desired operation of electrophoretic separation by utilizing a channel formed in the lidded microchip, aqueous solvent contained in the electrophoretically separated liquid sample held in the channel is frozen, and the end of the lid part sealing the groove-shaped channel formed on the substrate part is lifted up at a predetermined speed while keeping the whole electrophoretically separated sample in the frozen state, and peeled and removed from the substrate part under a condition to maintain the bend of a predetermined radius of curvature.

### TECHNICAL FIELD

The present invention relates to a method of processing, when using a lidded microchip for analysis, the sample to be analyzed in the lidded microchip; a method of automating the processing; an automatic sample processing apparatus based on the method; and a biosubstance analyzing apparatus to which the automatic sample processing method is applied. The present invention further relates to a lidded microchip for analysis solely used for the application of the processing method. More specifically, the present invention relates to a processing method suitably applicable to a sample to be analyzed in a lidded microchip in detaching the lid and processing the sample, a method of automating the processing, an automatic sample processing apparatus conforming to the automated processing technique, and further to a lidded microchip having a suitable constitution for said processing method.

### BACKGROUND ART

Regarding a sample containing biosubstances or chemical substances, when any biosubstances including protein and nucleic acid or any chemical substances, which are contained in the sample, are analyzed to identify them, the biological or chemical substances are separated by one of variety of separating techniques including electrophoresis and chromatography, and then bioassaying or chemical assaying is used for the purpose of specifying the properties of the separated substances and the quantities thereof. In these analytical methods, at the step of separating biosubstances or chemical substances, capillary tubes or column tubes are used according to the separating means applied, such as electrophoresis or chromatography. In the bioassay or chemical assay of the target substances being separated, after the separation step, measurement for biological reactions, biochemical reactions and chemical reactions are carried out in various types of well plates.

Especially, in the cases where the sample quantity itself is small or temperature control is required, a “microchip”, which allows fabrication of small-capacity channels by fine processing, and integration of the channels, which compresses the area needing temperature control, are useful. A microchip is a combination in a predetermined arrangement of a substrate, in which groove-shaped channels having a desired planar shape and a channel arrangement are formed, and a lid to cover these channels, the substrate and the lid being adhered or fixed to each other. A method by which the groove-shaped channel part that is provided in the microchip is used as the capillary space or column space to achieve separation by electrophoresis or chromatography and the well space provided in the channel part is used for bioassaying or chemical assaying is proposed (Non-Patent Document 1: Qinglu Mao et al., Analyst, vol. 124, 637-641 (1999)).

Multi-dimensional analysis, namely subjecting each single sample to a plurality of analyses, is suitable for more accurate identification of biosubstances and chemical substances. For example, as a protein sample has two characteristics including the isoelectric point and the molecular weight, the protein can be more accurately analyzed by obtaining information on both characteristics than relying on only one. In view of this point, apparatuses are proposed in which a sample is introduced into a channel in a microchip and subjected to isoelectric point separation corresponding to electrophoresis in the channel, after that, MALDI-MS (matrix-assisted laser desorption/ionization mass spectrometry) is applied on the sample separated along the channel to collect information on its spot positions and molecular weight (Non-Patent Document 2: Michelle L.-S. Mok et al., Analyst, vol. 129, 109-110 (2004) and Patent Document 1: WO 03/071263 A1). The apparatuses are so constituted that the “microchip” itself is cooled and subjected to temperature control over a thermoelectric cooler and the top of each of the groove-shaped channels is sealed with a lid in order to prevent the solvent from evaporating away by heating up the liquid in the fine channel, which is caused by the high voltage applied accompanying with the isoelectric point separation.

After completion of the separating operation, such as electrophoresis, the lid is removed and the solvent in the groove-shaped channel is caused to quickly evaporate away by heating or placing in a vacuum the substrate thereby to dry and solidify the separated proteins at each spot point. An appropriate matrix material is added into the groove-shaped channel to hold the separated proteins on the microchip, and MALDI-MS measurement along the channel is made to carry out the detection for each of the spot points.

Patent Document 1: WO 03/071263 A1t

Non-Patent Document 1: Qinglu Mao et al., Analyst, vol. 124, 637-641 (1999) Non-Patent Document 2: Michelle L.-S. Mok et al., Analyst, vol. 129, 109-110 (2004)

### DISCLOSURE OF THE INVENTION

### Problems to be Solved by the Invention

In order to further expand the range of applications of lidded “microchips”, the following function is desired for the lidded “microchip” that after the completion of the operation for separation on the microchip by means of separation, such as electrophoresis and chromatography, the lid can be easily detached from the substrate part, and then the substances separated in the channel can be subjected to operation of further analysis.

In the cases where the operation for further analysis is performed, there are some cases that it is necessary to collect the substances, which are separated in advance by the separation operation applying various separating techniques in the channel, at the next stage of analysis or the preparatory stage therefor. This step of collecting the separated substances from within the microchip involves the problem of susceptibility to the adverse effects described below.

First, in the case where such a mode is employed that a plurality of groove-shaped channels are formed in the microchip to construct the microchip having a plurality of lanes (electrophoretic channels), such a constitution is achieved that the top face of the groove-shaped channel formed in the substrate part is tightly sealed with the lid, and whereby the channel being tightly sealed is fit to the operation for separation such as electrophoresis corresponding to the conventional electrophoretic technique using capillaries. As a way to construct such a tightly sealed channel, it is desirable to place the top face of the substrate part in which the groove-shaped channel is formed and the bottom face of the lid part in a more solidly stuck state by using heat sealing or an adhesive layer. On the other hand, in the case where a more solidly stuck state is attained, in order to induce the peeling off between the top face of the substrate part and the bottom face of the lid part and then remove the lid part, an external force is applied to the lid part so as to forcibly peel it off, but this process might invite minute mechanical vibration. This minute mechanical vibration could promote mixing within the liquid present in the groove-shaped channels, and thus it may be a cause which stimulates, for instance, re-diffusion of the target substance separated as narrow spots in the groove-shaped channel. Further, during the time taken to conduct the removal of the lid part, as diffusion due to the concentration gradient within the liquid also progresses, re-diffusion of the target substance separated as narrow spots in the groove-shaped channel would occur to a certain extent. Therefore, different lanes (electrophoretic channels) are kept in a state of physically separated from one another and, thereby mixture of liquids between the lanes (electrophoretic channels) as well as liquid leaks, evaporation of the solvent and invasion of foreign matter can be avoided, but a phenomenon of re-dispersion of the separated target substance due to the very operation of removing the lid part does occur.

In particular, in the case where the substance that is in advance separated is stored in the liquid sample form as it is to supply it for further analysis or it is necessary to subject it to analysis in the liquid sample state, for instance in utilizing the biochemical or chemical reaction in the liquid phase as in bioassaying or chemical assaying, it is required to collect from within the microchip the substance that is in advance separated in the liquid sample state as it is. In the case where it is necessary to add a liquid reagent to the liquid sample of the in advance separated substance that is collected from within the microchip and mix them for reaction, the substance that is in advance separated by separating operation using the microchip is collected as liquid samples for individual fractions which are divided along the channel, and the individual fractions are then provided for analysis. In the step of separately collecting these individual fractions, there is a problem that, unless the operation is finished quickly, the following adverse effect will be suffered. The substance separated in a liquid form is turned into a different state from its desired state of separation by re-diffusion in the liquid as a change over time. Especially, if an unnecessarily long time is taken by this collecting operation, the re-diffusion of the separated substance will further proceed, which may invite a considerable deviation from the desired state of separation.

Moreover, if the operation for peeling and removal of the lid part is manually carried out, the length of time taken fluctuates with the skill level of the worker, and it is desired with a view to achieving high reproducibility to make the operation for peeling and removal of the lid part achievable by an automatic process.

The present invention will solve the problems stated above, and thus an object of the present invention is to provide the following sample processing method:

by using the method, after subjecting a sample liquid to be analyzed to an operation of desired separation by applying variety of separating techniques by using the lidded “microchip”, the operation for removing a lid part fixed to the top face of the substrate part, which are composed of a lidded “microchip” can be carried out with the re-diffusion of the separated target substance being restrained, and

in the case where the separated sample is to be stored in the state of the liquid sample as it is or is subjected to analysis of the next stage, though there would occur such “undesirable phenomena” as re-diffusion of the target substance separated in a liquid state and any change from the original separated state, by using the method, the operation for collecting the separated target substance from the “microchip” can be carried out with high reproducibility by help of an automated apparatus, while restraining such “undesirable phenomena”; and

to provide also an automatic sample processing apparatus based on the automatic sample processing method, and a lidded “microchip” available solely for the execution of the sample processing method.

### Means for Solving the Problems

The present inventors engaged in intensive research to solve the problems noted above, and obtained the series of findings described below.

First, they noticed that the two phenomena of “re-diffusion of the target substance”, which are the mixing of liquid by minute mechanical vibration caused by the very action of peeling and removing the lid part and the diffusion of the concentration resulting from the concentration gradient of the separated target substance, were phenomena incident to such situation that the substance is held as a solution in the channel formed in the lidded “microchip” even after completion of the operation of separation such as electrophoresis. Thus, the inventors discovered that placing in a solid phase state in which internal migration of substances was difficult, instead of keeping the solution state, would prevent substantially the two phenomena of “re-diffusion of the target substance”. Specifically, it was found that, after completion of the operation of separation such as electrophoresis, the operation for rapidly cooling the solution held in that channel is carried out to freeze the aqueous solvent contained therein and then the operation for peeling and removing the lid part is performed while keeping this frozen state, whereby both the mixing of liquid by minute mechanical vibration and the diffusion of the concentration due to the concentration gradient of the separated target substance could be avoided.

Further, the inventors found that, in a lidded “microchip”, where the sectional shape of the groove-shaped channel formed in the substrate part is a trapezoid of which the top side is longer than the bottom side or a rectangle of which the top side and the bottom side are equal and the adhesive strength pₜₒₚ per unit channel length of the part (top side) of the sample in the frozen state in contact with the bottom surface of the lid part surpasses the adhesive strength p_{bottom} per unit channel length of the parts (bottom side and two flanks) of the sample in contact with the wall faces of the substrate part, the sample in the frozen state comes off the wall faces of the substrate part and turns into a state in which it is stuck to the bottom surface of the lid part. The inventors found that, by utilizing this situation, the frozen sample could be taken out of the “microchip” in the state of being stuck to the bottom surface of the lid part to be removed. More specifically, first, in order to place the electrophoresed or otherwise separated sample in the channels in a sustained frozen state, the whole lidded “microchip” is held in a low-temperature condition far below the ice point. Even the lid-substrate contact faces which have a sufficient adhesive strength at or around room temperature quickly lose much of their adhesive strength at low temperature, sometimes falling below the adhesive strength manifested by the sample in the frozen state. In this case, when the peeling proceeds at the interface between the lid-substrate contact faces, no peeling takes place between the sample in the frozen state and the bottom surface of the lid part. The inventors further found that, when the adhesive strength pₜₒₚ per unit channel length of the part (top side) of the sample in the frozen state in contact with the bottom surface of the lid part surpasses the adhesive strength p_{bottom} per unit channel length of the parts (bottom side and two flanks) of the sample in contact with the wall faces of the substrate part, the sample in the frozen state comes off the wall faces of the substrate part and turns into a state in which it is stuck to the bottom surface of the lid part. It was also found that, instead of placing the top face of the substrate part in which groove-shaped channels are formed and the bottom surface of the lid part in a more firmly adhered state by using a heat seal or an adhesive layer, holding the sealing performance by applying a mechanical external pressure to the top face of the substrate part in which groove-shaped channels are formed and the bottom surface of the lid part to reinforce the only weak adhesion that is manifested, but a similar situation prevailed when such a mechanical external pressure was withdrawn.

The inventors further found that, because a frozen sample solution had the advantage of being solid and therefore easier to handle, the frozen sample solution could be divided into individual fractions, and each of the fractions could be transferred to a predetermined position to be further processed.

On the basis of the findings so far stated, the inventors have completed the present invention by verifying that,

In the case where the sectional shape of the groove-shaped channel formed in the substrate part of the lidded “microchip” is a trapezoid of which the top side is longer than the bottom side or a rectangle of which the top side and the bottom side are equal, and the adhesive strength pₜₒₚ per unit channel length of the part (top side) of a sample which is in a frozen state in contact with the bottom surface of the lid part surpasses the adhesive strength p_{bottom} per unit channel length of the parts (bottom side and two flanks) of the sample in contact with the wall faces of the substrate part,

it is possible to carry out the operation to remove the lid part adhered and fixed to the top surface of the substrate part in the lidded microchip with the sample, which has been separated in the groove-shaped channels formed in the substrate part, being kept adhered to the bottom surface of the lid part in a sustained frozen state

by subjecting the separated liquid sample held in the channels to an operation to freeze the solution contained

after performing a desired separating operation, to which a separating method such as electrophoresis to the liquid sample to be analyzed by utilizing the channels formed in the lidded microchip is applied, and

performing an operation to peel and remove the lid part sealing the top surface of the groove-shaped channel formed in the substrate part from the substrate part

while keeping the sample, which is separated in the channel, in the sustained frozen state;

further that the sample in the frozen state can be divided into individual fractions, which are transferred to predetermined positions and subjected to further processing; and

this series of operations can be automated.

Thus, the lidded microchip according to the present invention is:

a microchip characterized in that:

the sectional shape of the groove-shaped channel formed in the substrate part of the lidded “microchip” is a trapezoid of which the top side is longer than the bottom side or a rectangle of which the top side and the bottom side are equal; and the microchip comprises the lid and substrate being made of such materials that:

the adhesive strength pₜₒₚ per unit channel length of the part (top side), at which a sample which is in a frozen state is in contact with the bottom surface of the lid part (top side), surpasses the adhesive strength p_{bottom} per unit channel length of the parts (bottom side and two flanks), at which the sample is in contact with the wall faces of the substrate part.

In addition, a method of processing a sample in the lidded microchip according to the present invention is:

A method for processing, after subjecting a liquid sample to be analyzed to a desired operation of separating by applying predetermined separating technique with use of a channel formed in the lidded microchip, a separated liquid sample held in the channel formed in the lidded microchip, characterized in that:

said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,

after completing the desired operation of separation of the liquid sample to be analyzed by utilizing the channel formed in the lidded microchip, the method comprises the following steps:

a step of refrigerating in which the separated liquid sample held in the channel is subjected to an operation to freeze the aqueous solvent that is contained therein by refrigerating the substrate part of said lidded microchip to achieve a predetermined low-temperature condition at or below the ice point;

a step of peeling the lid part step off in which, for the purpose of causing the sample to come off from the groove-shaped channel in the state of adhering to the bottom surface of the lid part while maintaining the separated sample in a sustained frozen state by keeping the substrate part of said lidded microchip refrigerated at said predetermined low temperature,

an operation for peeling and removal of the lid part off the substrate part is carried out by applying an external force to an end of the lid part to peel the bottom surface of the lid part off the top surface of the substrate part, in order to perform an operation to release the adhesive strength which has brought the top surface of the substrate part and the bottom surface of the lid part in tight contact with each other and achieved an adhered state in a predetermined arrangement, while maintaining a condition relative to a predetermined threshold R_{eq2} that the radius of curvature R manifested by the local bending of the lid part on the interface where the peeling is proceeding is greater than said threshold R_{eq2} (R>R_{eq2}); and

a step of detaching the lid part in which, after the end of said peeling off step, an operation for transferring and turning over is carried out in such a manner that the lid part separated by releasing from the adhesion and fixation to the top surface of the substrate part is transferred away from the top surface of the substrate part, while maintaining a state in which said separated sample is sustained in the frozen state and kept in the state of adhering to the bottom surface of the lid part, and then the top surface and the bottom surface of the lid part are turned over upside down, and the separated lid part is held in an arrangement in which the separated sample adhering to the bottom surface of the lid part in the sustained frozen state is exposed on the surface thereof;

wherein the series of these steps are sequentially performed. It may as well be an automatic sample processing method wherein the series of these steps are automatically performed. In the method, the operation of separation to be applied to the liquid sample to be analyzed by utilizing the channel formed in the lidded microchip include electrophoresis and liquid-phase chromatography, and for instance, electrophoresis, particularly isoelectric focusing is suitable.

Further, the method of processing a sample in the lidded microchip according to the present invention may as well have the following constitution:

after said step for detaching the lid part is completed,

the method further comprises:

a step for fractionating, in which the sample separated by applying the predetermined separating technique, which sample is kept in a sustained frozen state, is collected by isolating the sample out of the groove-shaped channel formed in the substrate part while maintaining it in a state of adhering to the bottom surface of the lid part, and then the separated sample is fractionated into a plurality of fractions along said channel,

whereby ingredient substances separated as spot points in the groove-shaped channel formed in the substrate part are caused to be contained in any one of said plurality of fractions; and

a step for treatment of fraction re-dissolution, in which each of sample fragments in the frozen state, which is contained in any one of the plurality of fractions that are corresponding to part of said separated sample, is subjected to re-dissolution treatment respectively to prepare each of fractionated sample liquids. The series of these steps can also be automatically carried out.

Further, an automatic sample processing apparatus for the lidded microchip according to the present invention is:

an apparatus for automatically processing, after subjecting a liquid sample to be analyzed to a desired operation of separating by applying predetermined separating technique with use of a channel formed in the lidded microchip, a separated liquid sample held in the channel formed in the lidded microchip, characterized in that:

said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,

the apparatus comprises the following systems to be provided for the lidded microchip in which the desired operation of the separation of the liquid sample to be analyzed has been completed by utilizing the channel formed in the lidded microchip:

a system for refrigerating the substrate part, which system is adapted for installation in an arrangement in contact with the substrate part of said lidded microchip;

a control unit for the refrigerating system, which unit is capable of maintaining at least the substrate part in a predetermined low-temperature condition at or below the ice point with refrigeration by the substrate part refrigerating system to be installed in the arrangement in contact with the substrate part;

a system for fixing the substrate part, which system is capable of fixing the substrate part of said lidded microchip in the arrangement in contact with said substrate part refrigerating system;

a system for applying an external force, which system has a function to apply to an end of the lid part an external force having a component in a direction substantially normal to the top surface of the substrate part to release the adhesive strength which has brought the top surface of the substrate part and the bottom surface of the lid part into tight contact with each other and thereby achieved an adhesion state in a predetermined arrangement;

a system for transferring the end of the lid part, which system is capable of transferring the end of the lid part in a direction substantially normal to the interface of contact between the top surface of the substrate part and the bottom surface of the lid part in synchronism with the external force application to the end of the lid part by said external force applying system;

a system for controlling a speed of transferring the end of the lid part, which system has a function to control the transfer speed of the end of the lid part so that, in the process of peeling the bottom surface of the lid part off the top surface of the substrate part by using the external force applying system and the lid part end transferring system, which systems works in synchronism on the end of said lid part, the radius of curvature R manifested by the local bending of the lid part on the interface where the peeling is proceeding is maintained in such a condition that, relative to a predetermined threshold R_{eq2}, the radius of curvature R is greater than said threshold R_{eq2} (R>R_{eq2});

a system for detaching the separated lid part, which system has a function that, after the operation to peel the lid part off the top surface of the substrate part is ended, the system holds the lid part which is separated from the top surface of the substrate part by releasing the adhesive fixation, transfers it away from the top surface of the substrate part, and then turns over the top surface and the bottom surface of the lid part upside down, so as to expose the bottom surface of the lid part upward; and

the apparatus further comprises a system for controlling an automatic operation thereof, which has a function to cause the actions of each of the systems accomplishing the series of operations set forth to be to be automatically accomplished in accordance with a predetermined process program. In the case, the operation of separation to be applied to the liquid sample to be analyzed by utilizing the channel formed in the lidded microchip include electrophoresis and liquid-phase chromatography, and for instance, electrophoresis, particularly isoelectric focusing is suitable.

Further, the automatic sample processing apparatus for the lidded microchip according to the present invention may as well have the following constitution:

in addition to each of the systems as described above,

the apparatus further comprises:

a system for fractionating, which has a function for cutting the sample in a sustained frozen state into fragments, in which, regarding the sample separated by applying the predetermined separating technique, which sample being kept in a sustained frozen state, is collected by isolating the sample out of the groove-shaped channel formed in the substrate part while maintaining it in a state of adhering to the bottom surface of the lid part, the separated sample is fractionated into a plurality of fractions belong said channel to prepare a plurality of sample fragments in a sustained frozen state, and

a system for treatment of fraction re-dissolution, which has a function for distribution and a function for thermal re-dissolving, in which each of the plurality of sample fragments in a sustained frozen state, which are prepared by fractionating the separated sample by using said system for fractionating, is distributed to each well of multi-well sample plate, and then each of the sample fragment is subjected to re-dissolution treatment to prepare each of fractionated sample liquids.

The present invention further provides a sample analyzing method, in which, after completion of a separating operation by separating technique utilizing the lidded microchip such as electrophoresis,

by applying the automatic sample processing method for the lidded microchip according to the present invention having the constitution described above,

in the step of peeling and removing the lid part which has sealed the top surface of the substrate part, the sample separated by applying the separating technique such as electrophoresis, which sample is kept in a sustained frozen state, is collected by isolating the sample out of the groove-shaped channel formed in the substrate part while maintaining it in a state of adhering to the bottom surface of the lid part;

after the step of peeling and removing the lid part which has sealed the top surface of the substrate part is performed post to the operation for separation by means of the separation such as electrophoresis, the sample separated by applying the separating technique such as electrophoresis, which sample is kept in a sustained frozen state, is fractionated into a plurality of fractions along said channel; and then

each of the fractions is further subjected to an operation for analysis such as bio-assay or chemical assay.

Hence, in the case where electrophoresis is selected as the separating technique, the sample analyzing method according to the present invention is:

a method for analyzing bio-sample, which is a method in which, after subjecting a liquid sample to be analyzed to a desired operation of electrophoretic separation by utilizing the channel formed in the lidded microchip, out of the electrophoretically separated liquid sample held in the channels formed in the lidded microchip, ingredient substances spot-separated on said channel are fractionated into a plurality of fractions along the channel, and then bioassay or chemical assay analysis of the spot-separated ingredient substances contained in the fractions is performed, characterized in that:

said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,

the method comprising:

a step of collection, in which, after completing the desired operation of electrophoretic separation of the liquid sample to be analyzed by utilizing the channel formed in the lidded microchip,

the lid part, with which the top surface of the substrate part is tightly covered by sealing, is peeled and removed out in accordance with the method for automatic sample processing for the lidded microchip having the constitution described above, and then

the electrophoretically separated sample, which is kept in a sustained frozen state, is collected by isolating the sample out of the groove-shaped channel formed in the substrate part while maintaining it in a state of adhering to the bottom surface of the lid part;

a step for fractionating, in which the electrophoretically separated sample maintained in a sustained frozen state is fractionated into a plurality of fractions along said channel, and

ingredient substances separated as spot points in the groove-shaped channel formed in the substrate part are caused to be contained in any one of said plurality of fractions;

a step for treatment of fraction re-dissolution, in which each of sample fragments in the frozen state, which is contained in any one of the plurality of fractions that are corresponding to part of said electrophoretically separated sample, is subjected to re-dissolution treatment respectively to prepare each of fractionated sample liquids;

a step of specifying the range of each fraction, regarding each of the plurality of fractions which are divided along the groove-shaped channel formed in the substrate part, identification of electrophoretic index values corresponding to the two ends of the fraction is made on the basis of information on the positions of the two ends of the fraction on the channel;

a step for assay analyzing the fraction, in which each of fractionated sample liquids is subjected to the bioassay or chemical assay analysis to determine whether or not any ingredient substance showing the specific properties that can be identified by the assay analysis is contained in the fraction; and

a step for analyzing data, in which it is determined on the basis of the result of the bioassay analysis of the fraction whether or not the ingredient substance exhibiting the specific properties that are identifiable by said bioassay analysis is separated as a spot point in the range of the fraction in question, and

information on the range of electrophoretic index values that identify the range of each fraction, in which on the basis of which it is determined that the ingredient substance exhibiting the specific properties that are identifiable by said assay analysis is determined to be separated as a spot point is acquired along the groove-shaped channel.

### EFFECTS OF THE INVENTION

By utilizing the lidded microchip, sample processing method for the lidded microchip, the automatic sample processing method for the lidded microchip and the automatic sample processing apparatus for the lidded microchip according to the present invention, the operation for peeling and removing the lid part adhered and fixed to the top face of the substrate part, which parts compose the lidded “microchip”, after the operation of separation such as electrophoresis for the sample liquid to be analyzed is performed by using the lidded “microchip”, can be carried out while restraining the re-diffusion of the separated target substance, and enabled to be automated with a high level of reproducibility.

In addition, following the automated operation with high reproducibility to peel and remove the lid part, in the operation of sample preparation prior to further analysis using the separated sample by applying a separating technique such as electrophoresis, above all storage and analysis of the liquid sample as it is, for instance bioassay or chemical assay analysis, it is possible to restrain re-diffusion or change in the state of separation and also to achieve automation with a high level of reproducibility. Therefore, even if a large number of sample liquids to be analyzed are to be subjected to a separating operation such as electrophoresis, the process for processing sample, in which the sample separated by applying the separating technique such as electrophoresis is subjected to sample processing in order to provide the prepared samples to further analysis, can be attained with a high level of reproducibility.

### BRIEF DESCRIPTION OF THE DRAWINGS

FIG. 1 is a drawing schematically illustrating the problem to be solved by the present invention;

FIG. 2 is a drawing schematically illustrating an example of channel of a microchip used in the present invention;

FIG. 3 is a drawing schematically illustrating an example of constitution of a lidded microchip used in the present invention;

FIG. 4 is a drawing schematically illustrating another example of constitution of the lidded microchip used in the present invention;

FIG. 5 is a drawing schematically illustrating an example of lid part peeling system available for use in an automatic sample processing apparatus according to the present invention, and illustrating the working principle utilized in the peeling system of a first exemplary embodiment;

FIG. 6 is a drawing schematically illustrating an example of lid part peeling system available for use in the automatic sample processing apparatus to the present invention, and illustrating the working principle utilized in the peeling system of a second exemplary embodiment;

FIG. 7 is a drawing schematically illustrating an example of lid part peeling system available for use in the automatic sample processing apparatus to the present invention, and illustrating the working principle utilized in the peeling system of a third exemplary embodiment;

FIG. 8 is a drawing schematically illustrating an example of lid part peeling system available for use in the automatic sample processing apparatus to the present invention, and illustrating the working principle utilized in the peeling system of a fourth exemplary embodiment;

FIG. 9 is a drawing schematically illustrating an example of lid part peeling system available for use in the automatic sample processing apparatus to the present invention, and illustrating the working principle utilized in the peeling system of a fifth exemplary embodiment;

FIG. 10 is a drawing schematically illustrating an example of lid part peeling system available for use in the automatic sample processing apparatus to the present invention, and illustrating the working principle utilized in the peeling system of a sixth exemplary embodiment;

FIG. 11 is a drawing schematically illustrating an example of lid part peeling system available for use in the automatic sample processing apparatus to the present invention, and illustrating the working principle utilized in the peeling system of a seventh exemplary embodiment; and

FIG. 12 is a drawing schematically illustrating another example of channel of the microchip to be used in the present invention.

The following symbols used in the drawings respectively have the meanings respectively stated below.
101 Planar lid base part
102 Adhesive resin film layer
103 Substrate part
105a, 105b, 105c, 105d Liquid reservoir
107a Injection channel
107b Separating channel
110 Electrode terminal fixing member
112 Lidded microchip
113 Lid part

### BEST MODE FOR CARRYING OUT THE INVENTION

The present invention will be explained in more detail below.

The sample to be processed in the sample processing method or the automatic sample processing method using the microchip according to the present invention is an separated liquid sample, which is prepared by subjecting the liquid sample to be analyzed to a desired operation for separation with use of the channel formed in the lidded microchip, and thereby the plurality of substances contained in the liquid sample are positionally separated by applying the separating technique such as electrophoresis so as to form the spots located along the channel.

The separated fluid sample having undergone the operation of separation by using the separating technique such as electrophoresis is held in a liquid state in the channel formed in the lidded microchip at the time a predetermined operation of separation has ended. When the separated fluid sample having undergone the operation of separation by using the separating technique such as electrophoresis is to be used as the sample in a subsequent analysis, it has to be subjected to sample preparation processing according to the analytical technique to be applied subsequently.

For instance, in the case where the subsequent analytical technique is a bioassay or chemical assay analysis utilizing a reaction in the liquid phase, an operation to fractionate the sample into a plurality of fractional samples is so performed that each of the substances, which are positionally separated to form spots along the channel, is contained in any one of the plurality of fractions divided along the channel. After that, each of the fractional samples is analyzed by assaying in accordance with the predetermined reaction procedure, whereby evaluation is made as to whether or not any target substance involved in the reaction is present in the fractional sample and, if any is, how amount thereof is contained in the fractional sample. The microchip, sample processing method, automatic sample processing method and automatic sample processing apparatus according to the present invention is used for the form of processing, in which, after the separating operation by utilizing the separating technique such as electrophoresis is carried out, the separated liquid sample in the channels formed in the lidded microchip is fractionated into a plurality of fractional samples divided along the channels without impairing the state of separation among the substances positionally separated from one another.

(Liquid Sample to be Processed, Separated by Using Technique Such as Electrophoresis)

First, a liquid sample separated by using the separating technique such as electrophoresis, which is target to be processed by the sample processing method, automatic sample processing method or automatic sample processing apparatus using the microchip according to the present invention, will be described below.

In the case where the channel formed in the lid-sealed microchip is to be utilized, electrophoretic separation equivalent to conventional capillary electrophoresis can be applied. Specifically, in the case where the biomolecules to be analyzed, which are contained in the liquid sample, are proteins, isoelectric focusing, which separates different proteins by utilizing the difference in isoelectric points indicated by each protein, or phoretic separation, which separates them from one another by utilizing differences in phoretic velocity deriving from differences in molecular weight, can be used. In the case where the biomolecules to be analyzed, which are contained in the liquid sample, are nucleic acid molecules, phoretic separation, which separates different nucleic acid molecules by utilizing differences in length of the base, namely differences in phoretic velocity deriving from differences in molecular weight, can be used.

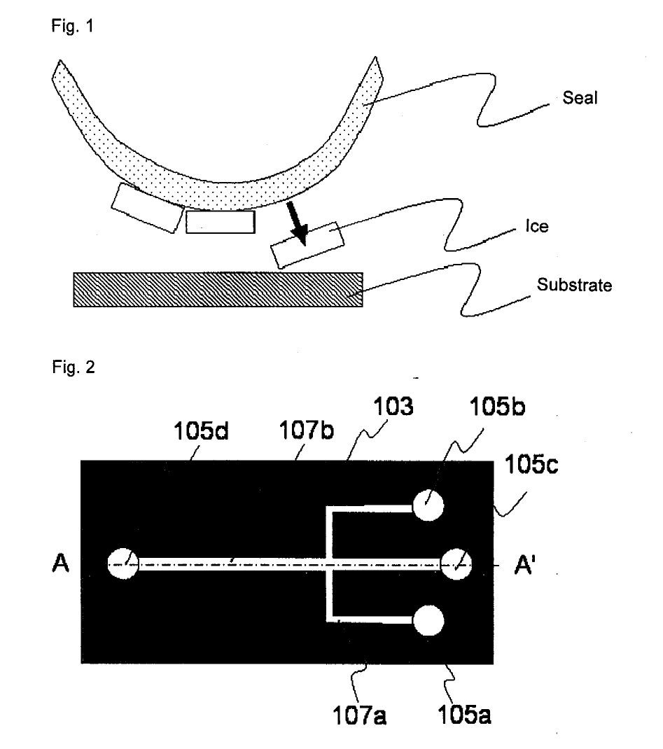

In such cases, the planar shape of the channel itself formed in the lidded microchip, the arrangement of the channel and the length of the channel are appropriately selected according to the method of electrophoretic separation used. For instance, the channel constitution having the planar shape shown in FIG. 2 can be selected. In the channel constitution shown in FIG. 2, a separating channel 107b for use in separation by isoelectric focusing and an injection channel 107a for introducing biomolecules to be focused on, for instance proteins, to the channel 107b are equipped on the top face of a substrate part 103. At the two ends of the separating channel 107b, liquid reservoirs 105d and 105c are formed, and acid and basic liquids for providing a pH gradient are introduced into the liquid reservoirs 105d and 105c, into which the terminals of electrodes for applying electric field therebetween are inserted. Liquid reservoirs 105a and 105b are also formed at the two ends of the injection channel 107a. Electrodes for applying electric field are also inserted into the liquid reservoirs 105a and 105b to generate electric field for use in the migration of proteins in the injection channel 107a. At the two ends of the separating channel 107b, liquid reservoirs 105d and 105c are formed, and acid and basic liquids for providing a pH gradient are introduced into the liquid reservoirs 105d and 105c, into which the terminals of electrodes for applying electric field therebetween are inserted. Liquid reservoirs 105a and 105b are also formed at the two ends of the injection channel 107a. Electrodes for applying electric field are also inserted into the liquid reservoirs 105a and 105b to generate electric field for use in the migration of proteins in the injection channel 107a.

In the case where the electrophoretic separation utilized is isoelectric focusing, it is also possible to select a channel constitution in which the injection channel 107a in the channel constitution shown in FIG. 2 is omitted, and only the separating channel 107b for use in separation by isoelectric focusing is provided. FIG. 12 shows an example of channel constitution provided only with the separating channel 107b for use in separation by isoelectric focusing. The liquid reservoirs 105d and 105c are formed at the two ends of the separating channel 107b built in the top face of the substrate part 103, and acid and basic liquids for generating a pH gradient are introduced into these liquid reservoirs 105d and 105c. Electrode terminals for applying electric field are inserted to generate electric field for use in the migration of proteins in the separating channel 107b. Incidentally, though the shape of the separating channel 107b shown in FIG. 12 is a single-lane constitution, it can be expanded into a multi-lane type microchip in which a plurality of groove-shaped channels are provided in the top face of the substrate part 103.

Other separating techniques than the aforementioned electrophoretic separation, which techniques are applicable by using the channels formed in the lidded microchip, include separation by liquid phase chromatography. The constitution for the procedure is such that the channel formed in the lidded microchip are filled with the column fillers used for the liquid phase chromatography, and the aqueous eluent medium is let flow at a predetermined rate from one end to the other of the channel. Column fillers suitable for use by filling the channel formed in the lidded microchip include those having a fine particle size and a relatively expanded sectional area of adsorption. Examples of column fillers fit to the column channel having such a fine sectional area include silica particles and polymer particles. The length L of the column channel formed in lidded microchip is selected from a range of 10 mm to 2000 mm, preferably from a range of 50 mm to 400 mm. It is desired that the pore size of the column agent to be used is selected from a range of 1 nm to 50 nm, and the specific surface area of the column filler is selected from a range of 30 mm²/g to 800 mm²/g.

(Structure of Lidded Microchip and Electrophoretic Operation Using it)

The lidded microchip is composed of the substrate part 103, in whose top surface a groove-shaped channel having the section being shaped in a trapezoid of which the top side is longer than the bottom side or a rectangle of which the top side and the bottom side are equal, are formed and a lid part 113, with which the top surface of the groove-shaped channel is tightly covered by sealing. Incidentally, holes for liquid injection are formed in the lid part 113, respectively matching the liquid reservoirs provided at the ends of the groove-shaped channel, while the top face of the groove-shaped channel is completely covered therewith. The lid part 113 is composed of a planar lid base part 101 having a function to hold the mechanical strength of the lid part 113 and, on its bottom face, an adhesive resin film layer 102 used for adhesion to the top surface of the substrate part 103. The holes for liquid injection built in the planar lid base part 101 and the adhesive resin film layer 102 are aligned with the liquid reservoirs 105d and 105c and the liquid reservoirs 105a and 105b. Further, the holes for liquid injection built in the planar lid base part 101 and the adhesive resin film layer 102, are also used when the electrode terminals for applying electric fields are inserted into the liquid reservoirs 105d and 105c and the liquid reservoirs 105a and 105b. Incidentally, in some cases, it is possible to make up the planar lid base part 101 and the adhesive resin film layer 102 used for adhesion of its bottom face to the top surface of the substrate part 103 of the same material. When the same material is used for the two elements, they can be produced in an integrated form in advance.

In order to attach and fix the electrode terminals for applying electric fields into the holes for liquid injection in the planar lid base part 101, an electrode terminal fixing member 110 is equipped to the planar lid base part 101 in advance. Prior to the electrophoretic operation, the electrode terminals for applying electric fields can be fixed by utilizing the electrode terminal fixing member 110, and at the stage of transferring from the end of the electrophoretic operation to the automatic sample process, the electrode terminals for applying electric fields are detached from the electrode terminal fixing member 110. Such lid base part 101 and electrode terminal fixing member 110 can either be made of different materials and assembled or made of the same materials, and in the latter case, they may be produced in an integrated form in advance. These attaching and detaching operations of the electrode terminals for applying electric fields accompanying the electrophoretic operation can be accomplished, after arranging and fixing the lidded microchip in a predetermined position with the microchip fixing system of the electrophoretic apparatus, by using an electrode terminal attaching/detaching system for which the mutual positions of the plurality of electrode terminals for applying electric fields to be used have been determined in advance. Of course it is also possible to attach and detach the electrode terminals and fix the lidded microchip by manual operation, but it is possible to make the microchip fixing system and the electrode terminal attaching/detaching system, which the electrophoretic apparatus is provided with, be constituted in an automatically operable form. Since it is desirable in particular in the present invention, after completion of the electrophoretic operation, to automatically carry out a series of sample processing operations with the microchip itself held in its position, it is preferable to have a form of automating the operations of attachment and detachment of the electrode terminals and the operation to fix the lidded microchip.

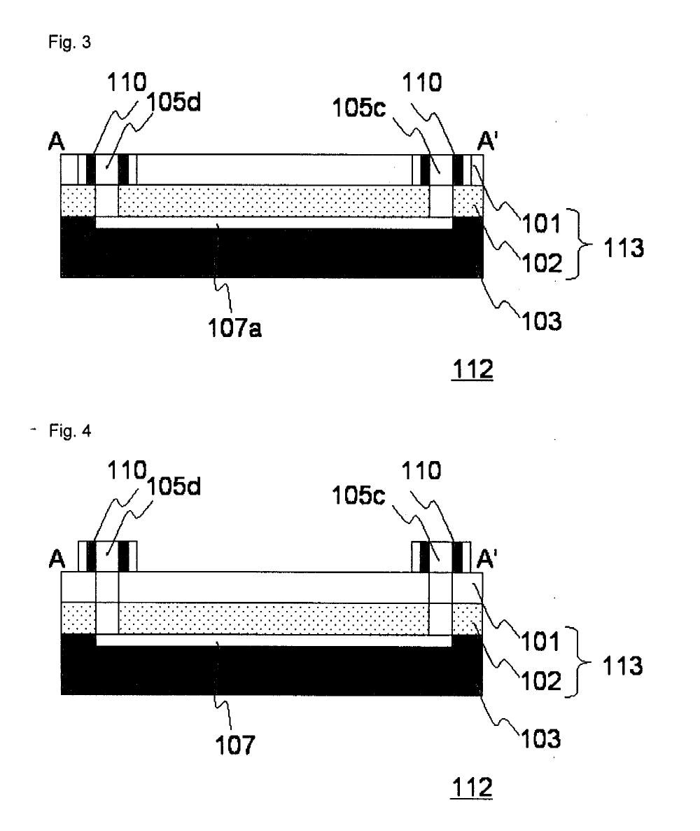

Incidentally, in the exemplary constitution shown in FIG. 3, the electrode terminal fixing member 110 is equipped and fixed in a form of constituting also the side wall part of the holes for liquid injection built in the planar lid base part 101, and it is also possible to select a structure in which the electrode terminal fixing member 110 is equipped and fixed in a form of coupling to the upper ends of the holes for liquid injection built in the planar lid base part 101 as in another constitution shown in FIG. 4.

The substrate part 103 and the lid part 113 are aligned with each other in terms of the positions of their respective holes for liquid injection and liquid reservoirs to constitute a structure in which the top face of the groove-shaped channel 107a is tightly covered by sealing with the lid part 113 by means of sticking the top face of the substrate part 103 and the bottom face of the lid part 113, namely the adhesive resin film layer 102, to each other. For bonding the planar lid base part 101 and the adhesive resin film layer 102, bonding means manifesting high bonding performance is employed; and when the lid part 113 is to be peeled and removed at the latter step, such a form that its peeling occurs on the adhesive plane between the top face of the substrate part 103 and the adhesive resin film layer 102 is selected. Thus, the adhesive plane between the top face of the substrate part 103 and the adhesive resin film layer 102 will exhibit a sufficient adhesive strength to achieve a closely enough adhered state to be free from such a fault that the phoretic liquid filled in the channel might leak or soak out from the groove-shaped channel 107a formed in the top face of the substrate part 103, but peeling will be enabled to take place along this adhesive plane by applying a predetermined external force.

When the automatic sample processing method or the automatic sample processing apparatus according to the present invention is to be applied, it is preferred that adhesive strength of the adhesive resin film layer 102 itself is set low, but the closely adhered state between the top surface of the substrate part 103 and the adhesive resin film layer 102 is kept by help of loading of a sufficient external force to cover the shortage. As means of loading that external force to keep the substrate part 103 and the lid part 113 in tight adhesion, a load-weight applying system in a form of applying the load-weight on the upper surface of the lid part 113 is available. It is desirable to select for this load-weight applying system a form in which the load-weight can be substantially uniformly dispersed over the whole adhesive faces of the substrate part 103 and the lid part 113. In addition, it is preferable to use a form permitting automatic operation, as does the microchip fixing system and the electrode terminal attaching/detaching system, to remove the load-weight in the operation to peel and remove the lid part 113. For instance, the load-weight applying system and the electrode terminal attaching/detaching system can be integrated to cause the electrode terminal attaching/detaching system to fit electrode terminals after the load-weight is applied by the load-weight applying system.

As for the top face of the substrate part 103, such a material is to be selected which material permits achievement of the intended processing precision when the aforementioned processing of the fine structure is carried out to fabricate the fine groove-shaped channels 107 therein. According to the method of electrophoresis to be used, the sectional shape of the groove-shaped channels to be formed is selected in the channel width (W₁) and channel depth (D₁) range of 5 μm to 1000 μm. The fine groove-shaped channels of this “microchip” are mainly used for the operation of electrophoretic separation using an infinitesimal quantity of liquid sample, in place of capillary electrophoresis. Therefore, it is desirable to select the sectional area (D₁×W₁) of the fine groove-shaped channels to be as small as the inner sectional area of the capillary tube, for instance in a range of not exceeding the sectional area of the inner diameter of 100 μm. On the other hand, the ratio (D₁/W₁) of channel depth (D₁)/channel width (W₁) is appropriately selected, with the material of the substrate part 103 and the processing precision determined by the means for fine processing of the groove-shaped channels also being taken account. Generally, since an excessively high ratio (D₁/W₁) would increase the difficulty of processing, it is desirable to select the ratio in a range of 1/100≦D₁/W₁≦10.

On the other hand, in the embodiment where, in place of the electrophoretic method, chromatography is used to carry out the operation for separation, such a mode that the channel is filled with column agents is chosen. In a mode that the channel is filled with the column agents at a high density, there are some cases where 60% to 80% of the capacity of the channel may be occupied by the column agents. The sectional shape of the groove-shaped channel to be built is so selected as to keep the volume of the sample liquid per unit channel length in the proper range according to the method of chromatography and the type of column agents to be used and the filling ratio of the column agents. Therefore, the sectional shape of the groove-shaped channel built in terms of the channel width (W₁) and depth (D₁) is selected from a range of 5 μm to 5000 μm, more preferably from a range of 20 μm to 1000 μm according to the method of chromatography used and its conditions. Usually the ratios between the column channel length and the channel width (W₁) or the channel depth (D₁) (L/W₁, L/D₁) are selected from a range of 5 to 400, preferably from a range of 20 to 300, more preferably from a range of 50 to 300.

Especially, in the case where the automatic sample processing method or the automatic sample processing apparatus according to the present invention is to be applied, it is necessary for the sample in a frozen state to satisfy the condition that the adhesive strength pₜₒₚ per unit channel length of the part (top side) of the sample in contact with the bottom surface of the lid part surpasses the adhesive strength p_{bottom} per unit channel length of the parts (bottom side and two flanks) of the sample in contact with the wall faces of the substrate part. For this reason, in order to restrain the relative contribution of the side walls of the channel, usually it is desirable for the ratio (D₁/W₁) between the depth (D₁) and the width (W₁) of the channel, which may be selected appropriately, with the processing accuracy being determined by the material of the substrate part 103 and the means of fine-processing of the groove-shaped channel also taken into account, to be in a range of D₁/W₁≦1.

In the case where the automatic sample processing method or the automatic sample processing apparatus according to the present invention is to be applied, as the separated sample obtained by the operation of separation such as electrophoresis is taken out in a sustained frozen state, the sectional shape of the groove-shaped channel can be rectangular, or trapezoidal with a greater width of the open top part (W_{1 top}) of the groove than the width of the bottom part (W_{1 bottom}) thereof (W_{1 bottom}<W_{1 top}), which would facilitate taking out the sample in the frozen state.

As the material of the substrate part 103, for instance, materials suitable for fine-processing such as quartz, glass or silicon, or materials capable of achieving the intended fine-processing accuracy that are chosen from highly insulative plastics such as polycarbonate, PDMS or PMMA are suitable used.

In the present invention, at the step in which peeling is to be accomplished, the substrate part 103 is not elastically deformed, but the lid part 113 is, and a bent structure is provided on the boundary of peeling; in order to minimize the extent of that bending, a material that shows flexibility but exhibits only slight elastic deformation is used for the planar lid base 101.

In the present invention, such a material that is capable of being subjected to processing, such as building the holes for liquid injection therein, is excellent in insulating performance, and also has flexibility is suitably used for the material for the planar lid base part 101. For instance, one can be selected from acryl resins including PMMA (polymethyl methacrylate) and polymeric resins including PDMS (polydimethyl siloxane), especially a flat material that will be easily processed but is not susceptible to fracture even if the thickness is thin, is preferably used. For the material used for the base of the adhesive resin film layer 102, for instance, PDMS, one of polyorefines including PTFE (polytetrafluoroethylene), PP (polypropylene), PE (polyethylene) and polyvinyl chloride, or a polyester is used. For the adhesive resin film layer 102, it is preferable to use a material higher in elastic deformability than the material for the planar lid base part 101.

In this invention, in order to take out the sample separated by means of separation such as electrophoresis, which sample in the sustained frozen state is adhered on the surface of the adhesive resin film layer 102, it is desirable for the resin for use as the base resin for the adhesive resin film layer 102 to be able to keep the frozen object stuck to it. For the outermost layer of the adhesive resin film layer 102, though a form to which a coat of adhesive which gives some adhesive property is provided can be employed, it is desirable for the coat of adhesive to decline in adhesive strength when refrigerated.

In the lidded microchip itself, the external shape of the substrate part 103 is rectangular, and the external shape of the lid part 113 which seals its top face also is rectangular. When to peel and remove the lid seal part 113, in order to apply an external force to one end of the lid part 113, a part protruding from the external shape of the substrate part 103 may be provided at least toward the end used for the application of the external force. For instance, in the case where the direction of peeling and removing the lid part 113 is selected along the longer side of the rectangle of the external shape of the substrate part 103, the external shape of the lid part 113 is made greater in this longer side than the longer sides of the substrate part 103. When an external force is applied to the lid part 113, it is made possible to set its working point at the part protruding in the longer side thereof. Furthermore, after completion of the peeling and removing of the lid part 113, it is made possible to set in said protruding part an area for supporting the ends of the separated lid seal part by a holding system when the operation for detaching is carried out by holding and transferring the separated lid part away from the top face of the substrate part. Further, it is also possible to choose a mode in which a part protruding in the shorter side direction of the lid part 113 along the longer side of the substrate part 103 is used as a site to apply the external force when peeling and removing the lid part 113.

(System for Injecting Electrophoretic Liquid into Channels in Lidded Microchip)

There is not a rare case where the material of the lid part 113 making up the top surface of the channels in the lidded microchip may be poor in water-wettability. A capillary formed out of a highly water-wettable material allows the electrophoretic liquid to be supplied from one end of a channel to all over the capillary through the capillary phenomenon, but for the channels in the microchip having internal wall faces poor in water-wettability, it is necessary to provide a liquid injecting system, in place of electrophoretic liquid injection utilizing the capillary phenomenon. Specifically, it is preferable to use such a mode in which a pressure difference is created between liquid reservoirs provided at the ends of channels and the insides of the channels, and the resulted pressure difference is utilized for forcibly injecting the electrophoretic liquid supplied from one liquid reservoir into the channels.

As the channels themselves formed in the lidded microchip are tightly covered by sealing, when gas being left inside is pulled out through one liquid reservoir and the electrophoretic liquid is supplied to the other liquid reservoir, the electrophoretic liquid infiltrates into the channels due to the pressure difference between them. In that step, injection is stopped when the electrophoretic liquid has wholly filled the channels. In the case where the electrophoretic liquid injection technique utilizing the pressure difference is used, the operation for the electrophoretic liquid injecting can be automated by using such a constitution in which an aspirating system for pulling out gas being left inside is attached to one of the liquid reservoirs; a liquid feeding system with micro-liquid measure fit for injecting a predetermined quantity of the electrophoretic liquid is coupled to the other liquid reservoir; and further, the two systems are linked with a judgment system which automatically determines the end timing of its injection action.

As the judgment system which automatically determines the end timing of the injection action, for instance, a judgment system which utilizes such a detection unit as exemplified below to detect whether or not the injected electrophoretic liquid has wholly filled the channels can be used.

When the electrophoretic liquid has wholly filled the channels, as the electrophoretic liquid itself is a medium having some electroconductivity, a rapid change from an insulating state to a predetermined resistance can be observed by monitoring the resistance value between the two ends of each channel. By equipping such a resistance monitoring type detection unit at each end of each channel, in which the function of the electrophoretic liquid as an electroconductive medium is utilized, it is made possible to judge on the filled state of the electrophoretic liquid.

Further, the electrophoretic liquid is a liquid, and its dielectric constant differs markedly from that of a gas. By utilizing this feature, it is possible to use such a monitoring unit in which two electrodes of planar capacitor type are provided on the two side walls of each channel to detect the phenomenon that when the electrophoretic liquid infiltrates into the space between the electrodes, it brings on a change in capacitance. By equipping such a detection unit of planar capacitor type at each end of each channel, it is made possible to judge on the filled state of the electrophoretic liquid.

Furthermore, as the electrophoretic liquid is a liquid, it differs significantly from a gas in refractive index as in dielectric constant. For instance, in the case where the substrate part 103 is made of a light-transmissive material, the light reflectance at the wall faces of the channels formed in its top face changes when the electrophoretic liquid comes to cover the wall faces. When providing with such a reflectance detecting unit in which light reflectance from one wall face of a channel is detected by using the phenomenon, it is also made possible to decide whether or not the electrophoretic liquid has reached a part of the monitored wall face of the channel. By equipping each end of each channel with the liquid detecting unit of the wall face light reflectance monitoring type, it is made possible to judge the filled state of the electrophoretic liquid.

Automation of the whole electrophoretic liquid injecting operation can be achieved by integrating the system for judging the filled state of the electrophoretic liquid with use of the aforementioned liquid detecting units and the electrophoretic liquid injecting system utilizing the pressure difference and thereby automatically deciding the end timing of the injection operation.

(System for Fixing Substrate Part of Lidded Microchip, Substrate Part Cooling System and Control Unit for Cooling System)

When the lid part 113 is peeled and removed from the top face of the substrate part 103 of the microchip, after fixing the substrate part 103, the external force is applied to one end of the lid part 113 to forcibly displace the one end of the lid part 113 in a substantially perpendicular direction to the adhesive plane between the substrate part 103 and the lid part 113. Accompanying this displacement of its one end, the lid part 113 is given a flexible structure relative to the adhesive plane.

At the stage where the external force has been applied, the substrate part is fixed to prevent the substrate part 103 from moving. At the same time, prior to the operation to peel and remove the lid seal part 113, the electrophoretically separated liquid sample present in the groove-shaped channels of the substrate part 103 is cooled to place the whole liquid sample in a frozen state. This liquid sample is in a state in which soluble substances electrophoretically separated into the electrophoretic liquid are dissolved, forming spots. Although its solvent content is water, buffer contents and the like are dissolved therein, and thus because of the freezing point depression, its freezing starts at a temperature below the ice point (0° C.). For this reason, it is desirable to rapidly refrigerate the whole liquid sample down to a temperature significantly lower than the temperature at which freezing starts to once place it in a supercooled state, whereby the whole liquid sample in the groove-shaped channels freezes in an instant. On the other hand, if the solvent water is slowly frozen at a temperature slightly lower than the temperature at which freezing starts, freezing will start elsewhere than spots because, though the concentrations of dissolved substances are higher at spots, the concentrations of substances are low in other areas than the spots. In such a case, the volume expansion resulting from the freezing compresses the unfrozen areas around the spots, and it could cause leaking of the liquid out of the groove-shaped channels. In order to avoid such a situation, it is desirable to achieve a state in which freezing progress over the whole insides of the groove-shaped channels by rapidly refrigerating the liquid sample to a temperature significantly lower than the temperature at which freezing starts to once place it in a supercooled state.

Accordingly, it is preferable to utilize the substrate part cooling system which once achieves a supercooled state by rapidly cooling the liquid from the bottom face of the substrate part 103 of the microchip to bring the whole channel to a uniform temperature, which is significantly lower than the temperature at which freezing starts. Desirably, the refrigerating system may have an arrangement in which it is in uniform contact with the whole bottom of the substrate part, and a form in which the substrate part fixing system and the substrate part refrigerating system are integrated is desirable.

For the fixing of the substrate part, though a style in which the side wall parts of the substrate part are fixed is available, such a style of fixing the bottom face of the substrate part is preferable. For instance, such a style in which, after the bottom face of the substrate part is machined into a flat plane, the bottom face of the substrate part is fixed in a predetermined position on a fixed stage of a vacuum chuck system is suitably used. Although the thickness itself is a few mm or less, since the planar size of the substrate part 103 of the microchip is not as small as a few mm, but its short and long sides are well over 10 cm though not much larger than that, and therefore it is preferable to use a mode in which the face of the fixed stage of a vacuum chuck system is refrigerated to a predetermined temperature by utilizing refrigerating means such as a Peltier device.

Incidentally, in said substrate part fixing system being integrated with the substrate part refrigerating system, as the fixed stage face and the lid-sealed microchip are refrigerated to a temperature significantly lower than the ice point (0° C.), if the ambient atmosphere contains moisture, it will be condensed and become frozen. To prevent the condensation and freezing, the ambient atmosphere of the fixed stage face and the lidded microchip are so constituted as to be kept in a dry gaseous atmosphere containing no moisture. Specifically, it will have such a constitution that the area itself containing the substrate part fixing system and the substrate part refrigerating system is installed in an airtight sealed vessel, and the interior of this airtight sealed vessel is maintained as a dry air or dry nitrogen atmosphere.

In a state in which the liquid sample in the channels is not frozen, as the vibration could constitute a factor to cause liquid mixing in the channels during transportation, the substrate part 103 of the microchip is fixed, in the step of operating the above-described separation such as electrophoresis, to such integrated substrate part fixing system and substrate part refrigerating system in the position where the microchip is fixed. The substrate part fixing system and substrate part refrigerating system being integrated are provided for the electrophoretic apparatus and, at the time the operations for the separation such as electrophoresis has ended, the fixation of the substrate part 103 of the microchip and rapid refrigeration of the substrate part are promptly executed by the substrate part fixing system and substrate part refrigerating system being integrated.

At the stage of the operation for the separation such as electrophoresis, if some other fixing means is used for the fixation of the substrate part 103 of the microchip, a mode of transferring the integrated substrate part fixing system and substrate part refrigerating system to a position where close contact with the bottom of the substrate part 103 of the microchip can be accomplished is utilized. Alternatively, when the lid-sealed microchip is set and fixed in a predetermined position on the apparatus prior to the operation for the separation such as electrophoresis, even in such a case where such a substrate part fixing system and substrate part refrigerating system being integrated are used to fix, it is also possible to choose a mode in which the substrate part fixing system and substrate part refrigerating system being integrated can be transferred accompanying the operation for carrying-in of the lid-sealed microchip to be used.

In order to rapidly refrigerate the whole liquid sample down to a temperature significantly lower than the temperature at which freezing starts to once place it in a supercooled state, whereby the whole liquid sample in the groove-shaped channels freezes in an instant, it is desirable to set the refrigerating temperature to a range at least 10° C. to 30° C. lower than the ice point (0° C.), at least −20° C. or below. When refrigerated to said refrigerating temperature, the liquid sample is once placed in a supercooled state, and thereby the whole liquid sample in the groove-shaped channels proceeds to freezing in an instant. In that process, a slight volume expansion is caused to occur. In the case where the wall surfaces of channel are poor in water-wettability, corners of the rectangular section of the channel, especially the corners of the top surfaces of the channel coming into contact with the lid part 113, have regions not filled with liquid in a liquid state. However, when the liquid comes into a frozen state, such a state in which it comes into close contact with the bottom surface of the lid part 113 over the top surface of the channel is attained. Such situation which allows the sample separated by the method such as electrophoresis, which has come into this frozen state, to achieve the close contact with the bottom surface of the lid part 113 is a more preferable situation in applying the present invention, in which the adhesiveness of the bottom surface of the lid part 113 with the sample separated by the method such as electrophoresis, which has come into a frozen state is to be utilized.

The series of operations comprising the fixation of the substrate part 103 of the microchip by the substrate part fixing system, freezing of the liquid sample in the groove-shaped channels via the refrigeration of the substrate part 103 by the substrate part refrigerating system and subsequent temperature control to maintain the frozen state can be automated by the control unit of the refrigerating system and accomplished under predetermined conditions.

(System for Peeling and Removing Lid Part)

In the present invention, when the substrate part 103 and the lid part 113 composing lidded microchip are to be separated, a technique to peel and remove, after fixing the substrate part 103 of the microchip, the lid part 113 tightly stuck to the top face of the substrate part 103 is employed.

Specifically, in order to release the adhesive strength achieving a state of adhesion in a predetermined arrangement in which the top face of the substrate part 103 and the bottom face of the lid seal part 113 tightly stuck to each other, an external force having a component in a substantially perpendicular direction to the top face of the substrate part 103 is applied to an end of the lid seal part 113 to bend the lid seal part 113, and peeling is proceeded at a desired velocity in a form of lifting upward the end of the lid seal part 113 while keeping the bend at a predetermined curvature. In the present invention, at this stage of peeling the lid part 113, the state of adhesion is maintained on the top surface of the sample separated by the method such as electrophoresis, which has come into contact with the bottom surface of the lid part 113 and into a frozen state in the groove-shaped channel, and instead peeling off the wall faces of the groove-shaped channel proceeds, with the result that the peeling of the lid part 113 is completed in a state in which the sample separated by the method such as electrophoresis, which is kept in the frozen state, is adhered to the bottom surface of the lid part 113.

At first, the top surface of the substrate part 103 and the bottom surface of the lid part 113 are adhered to each other by an adhesive strength p₀ per unit area between the top surface of the substrate part 103 and the bottom surface of the lid part 113. In such a case, because of the adhesive strength between the top face of the substrate part 103 and the bottom face of the lid part 113, there is a range in which peeling does not begin even when one end of the lid part 113 is lifted in a direction substantially perpendicular to the top face of the substrate part 103 and the lid part 113 is bent. In a state in which an even greater bend is observed, there is a threshold at which peeling begins. The bent shape, at the time in which the threshold condition is satisfied, is defined by δ which is the quantity of displacement from the top face of the substrate part 103 at one end of the lid part 113 and L which is the length from the boundary where the top face of the substrate part 103 and the bottom face of the lid part 113 come into contact with each other to the working point of the external force imposed on the one end of the lid part 113, and manifests an arciform shape having a substantially constant radius of curvature R. Thus, with the angle of this arc being represented by θ, the following equations are satisfied.

L=R·θ

δ=R(1−cos θ)

When the bend is in this shape, the force P applied to the boundary where the top face of the substrate part 103 and the bottom face of the lid part 113 come into contact with each other is approximately expressed as follows wherein d is the thickness, b is the breadth and E is the effective Young's modulus of the lid part 113:

δ=P·(2L)³/{4bd³E}

P=δ·(4bd³E)/(2L)³

When the displacement quantity δ of one end of the lid seal part 113 is increased as δ→δ+Δδ, the radius of curvature R representing the bent shape varies as R→R−ΔR₁, and its arciform angle θ becomes θ→θ+Δθ₁, the transitional variation is described as follows:

$$\begin{matrix}L = ( R - Δ {R}_{1} ) \cdot ( θ + Δ {θ}_{1} ) \\ \approx R \cdot θ + \{ R \cdot {Δθ}_{1} - Δ {R}_{1} \cdot θ \}\end{matrix}$$

$$\begin{matrix}δ + Δδ = ( R - Δ {R}_{1} ) \cdot \{ 1 - cos ( θ + {Δθ}_{1} ) \} \\ \approx ( R - Δ {R}_{1} ) \cdot \{ 1 - cos θ + Δ {θ }_{1} \cdot sin θ \} \\ \approx R ( 1 - cos θ ) + \{ R \cdot Δ {θ}_{1} \cdot sin θ - Δ {R}_{1} \cdot ( 1 - cos θ ) \} \\ \approx R ( 1 - cos θ ) + Δ {R}_{1} \cdot \{ θ \cdot sin θ - ( 1 - cos θ ) \}\end{matrix}$$

When the bend is in this shape, the force P+ΔP₁ applied to the boundary where the top face of the substrate part 103 and the bottom face of the lid part 113 come into contact with each other is approximately expressed as follows:

P+ΔP₁=(δ+Δδ)·{4bd³E}/(2L)³

The peeling slightly proceeds as such decrease P+ΔP₁→P is attained. And thus, it returns to a state in which the peeling no longer proceeds. At the time of that peeling stop, the bent shape manifests an arciform shape having a substantially constant radius of curvature R.

$$\begin{matrix}L + Δ L = R \cdot ( θ + Δ {θ}_{2} ) & \\ \begin{matrix}δ + Δδ = R \cdot \{ 1 - cos ( θ + Δ {θ}_{2} ) \} \\ \approx R \cdot \{ 1 - cos θ + Δ {θ}_{2} \cdot sin θ \} \\ \approx R \cdot ( 1 - cos θ ) + R \cdot Δ {θ}_{2} \cdot sin θ\end{matrix} & \end{matrix}$$

At this stage, the force P−ΔP₂ applied to the boundary where the top face of the substrate part 103 and the bottom face of the lid part 113 come into contact with each other is approximately expressed as follows.

$$\begin{matrix}P - Δ {P}_{2} = ( δ + Δ δ ) \cdot \{ 4 {bd}^{3} E \} / {\{ 2 ( L + Δ L ) \}}^{3} \\ \approx ( δ + Δ δ ) \cdot \{ 4 {bd}^{3} E \} / \{ {( 2 L )}^{3} \cdot ( 1 + 3 Δ L \text{/} L ) \} \\ \approx ( δ + Δ δ ) \cdot ( 1 - 3 Δ L \text{/} L \cdot \{ 4 {bd}^{3} E \} \text{/} {( 2 L )}^{3}\end{matrix}$$

Thus, when the decrease: (P+ΔP₁)→(P−ΔP₂) are taken place, the ΔL part is peeled off. Therefore, the decrease in adhesive strength of the ΔL part corresponds to the change: (P+ΔP₁)→(P−ΔP₂). The adhesive strength p₀ per unit area between the top face of the substrate part 103 and the bottom face of the lid part 113 being represented by p₀:

$$\begin{matrix}( Δ {P}_{1} + Δ {P}_{2} ) = ( 3 Δ L / L ) \cdot ( δ + Δδ ) \cdot \{ 4 {bd}^{3} \} / {( 2 L )}^{3} \\ \approx {p}_{0} \cdot b \cdot Δ L\end{matrix}$$

In other words, when the peeling proceeds, it is estimated that a distortion (a small bend whose radius of curvature R is small) surpassing a threshold condition represented by:

3·(1/L)·P≈p₀·b

needs to be maintained on the boundary where the top face of the substrate part 103 and the bottom face of the lid part 113 come into contact with each other.

Thus, the external force imposed on the end of the lid part 113 is ½P, and is selected at least in a range where

(½P)>p₀·b·L/6

is maintained, which enables the peeling to proceed between the top surface of the substrate part 103 and the bottom surface of the lid part 113.

In the case where the automatic sample processing method or the automatic sample processing apparatus according to the present invention is to be applied, the maintenance of the close adhesive state between the top surface of the substrate part 103 and the bottom surface of the lid part 113 is to be attained rather by help of loading of a sufficient external force to keep the substrate part 103 and the lid part 113 in tight adhesion than by the adhesive strength of the bottom surface of the lid part 113 to the top surface of the substrate part 103, which strength is supplemented by the external force. At least at the time the aforementioned refrigerated temperature has been reached, the adhesive strength of the bottom surface of the lid part 113 to the top surface of the substrate part 103 is to be lower than a certain level. Specifically, in such a refrigerated situation, the adhesive strength p₁ per unit area between the bottom surface of the lid part 113 and the top surface of the sample separated by such a method as electrophoresis, which is kept in the frozen state, is set greater than the adhesive strength p₀ per unit area between the top surface of the substrate part 103 and the bottom surface of the lid part 113 (p₁>p₀). In addition, the adhesive strength p₁ per unit area between the bottom surface of the lid part 113 and the top surface of the sample separated by such a method as electrophoresis, which is kept in the frozen state, is to be greater than the adhesive strength p₂ per unit area between the groove-shaped channels and the bottom surface of the sample separated by such a method as electrophoresis, which in the frozen state (p₁>p₂).

In such a case, the threshold condition for peeling to proceed between the top surface of the sample separated by electrophoresis in the frozen state and the bottom surface of the lid part 113 is similarly represented by:

3·(1/L)·P≈p₁·b>p₂·b

The radius of curvature under this threshold condition is represented by R_{eq2}.

Thus, in the present invention, such a state that the radius of curvature R representing the bend on the boundary where peeling proceeds is not smaller than the radius of curvature R_{eq2} under the foregoing threshold condition; (R>R_{eq2}) is selected, and thereby peeling between the top surface of the sample separated by electrophoresis in the frozen state and the bottom surface of the lid part 113 is avoided, while peeling does proceed between the top surface of the substrate part 103 and the bottom surface of the lid part 113 and between the groove-shaped channel and the bottom surface of the sample separated by electrophoresis, which is kept in the frozen state.

On the other hand, when the radius of curvature R representing the bend of the bottom surface of the lid part 113 varies, especially when the radius of curvature R representing the bend abruptly decreases, a large shearing stress suddenly increases on the sample separated by such a method as electrophoresis, and cleavages take place along many flaws (grain boundaries) within the frozen body. Furthermore, the trouble shown in FIG. 1 may occur, namely these cleaved fragments are peeled and come off. Such a state in which the radius of curvature R representing the bend does not vary is maintained, and thereby, the phenomenon of coming off can be avoided, and thus the state in which the fragments is kept to be adhered to the bottom surface of the lid part 113 can be held.

The external force imposing system provided with a function to impose the external force having a component of a direction substantially perpendicular to the top face of the substrate part on the end of the lid part, the lid part end transferring system which transfers the end of the lid part in a direction substantially perpendicular to the boundary of contact between the top face of the substrate part and the bottom face of the lid part in synchronism with the imposition of the external force on the end of the lid part, and a lid part end transfer speed control system provided with a function to so control the transfer speed of the end of the lid part as to maintain the radius of curvature R, which is manifested by the local bend of the lid part on the boundary where the peeling proceeds, at a predetermined target value, at the step of peeling the bottom face of the lid part off from the top face of the substrate part, are integrally constituted, and the constitutions described below, for example, can be selected therefor.

### First Exemplary Embodiment

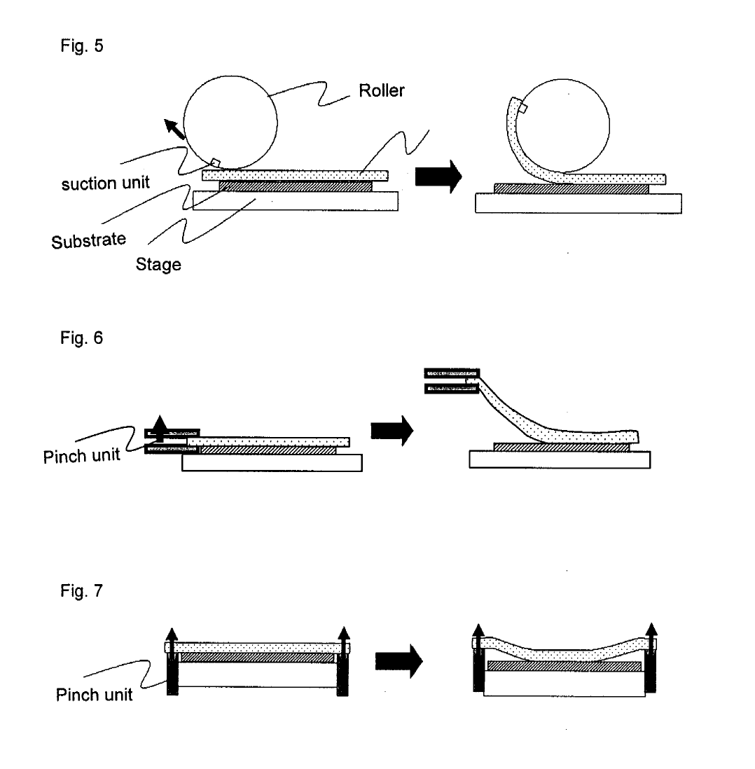

The peeling system for the lid part shown in FIG. 5 is of a type which, after vacuum-suction of an end of the lid part, winds it up by using a roller having a predetermined radius. The radius of curvature R representing the bend of the lid part becomes equal to the radius of the roller and, by keeping the winding speed constant, the transfer speed of the end of the lid part is also made constant.

According to the target value of the radius of curvature R representing the bend of the lid part, the radius of the roller is adjusted, and the winding speed is set.

### Second Exemplary Embodiment

The lid part peeling system shown in FIG. 6 is of a type which, after chucking an end of the lid part with a pinch, lifts it up. In this action, the lifting speed is selected according to the target value of the radius of curvature R representing the bend of the lid part.

### Third Exemplary Embodiment

The lid part peeling system shown in FIG. 7 is of a type which lifts one end or both ends of the lid part. The pinch unit or units for moving the end or ends of the lid seal part thrust upward the bottom face of the lid part. In this action, the lifting speed is selected according to the target of the radius of curvature R representing the bend of the lidl part.

### Fourth Exemplary Embodiment

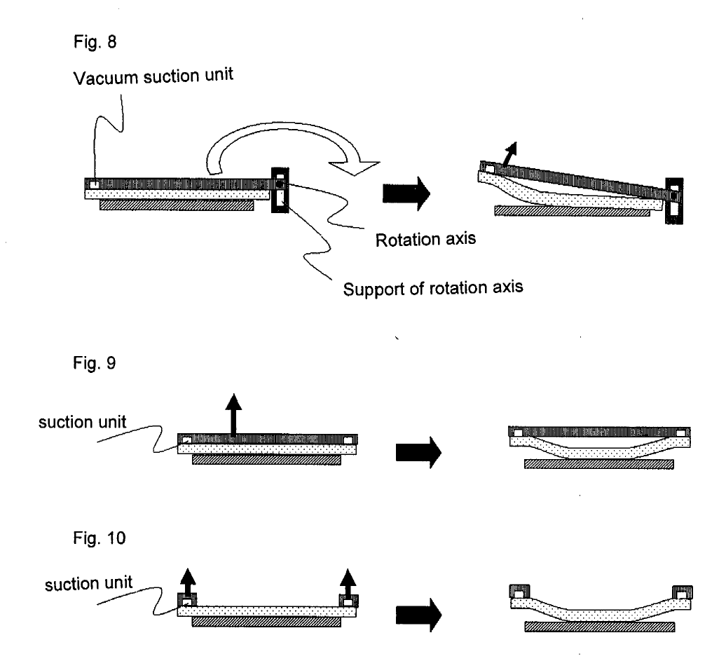

The lid part peeling system shown in FIG. 8 is of a type which, after an end of the lid part is chucked by a vacuum suction unit, lifts it. In this operation, the lifting speed is selected according to the target value of the radius of curvature R representing the bend of the lid part.

The control of the lifting speed is adjusted within a desired range by using the rotational angle of the lifting arm and the vertical moving speed of a stanchion supporting the rotation axis.

### Fifth Exemplary Embodiment

The lid part peeling system shown in FIG. 9 is of a type which, after an end of the lid part is chucked by a vacuum suction unit, lifts it. In this action, the lifting speed is selected according to the target of the radius of curvature R representing the bend of the lid part.

In some cases, a stage fixing the substrate part may be lowered to lift the substrate part in relative terms.

### Sixth Exemplary Embodiment

The lid part peeling system shown in FIG. 10 also is of a type which, after an end of the lid seal part is chucked by a vacuum suction unit, lifts it. In this action, the lifting speed is selected according to the target of the radius of curvature R representing the bend of the lid part.

In some cases, a stage fixing the substrate part may be lowered to lift the lid I part in relative terms.

### Seventh Exemplary Embodiment

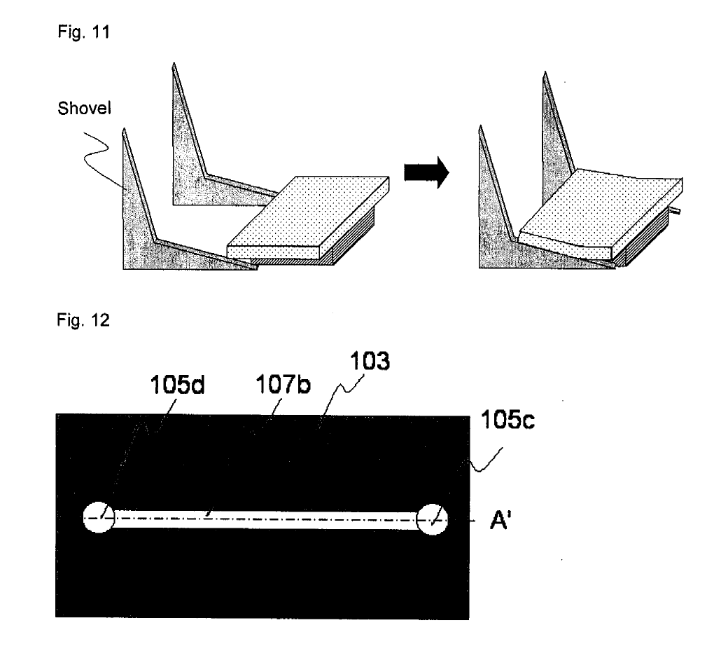

The lid part peeling system shown in FIG. 11 is of a type which, after a shovel-shaped guide unit having a predetermined slope angle is inserted from an end of the lid part, transfers the guide unit while lifting the end of the lid part along this slope. In this action, the radius of curvature R representing the bend of the lid part is controlled by selecting the transferring speed according to the target of the radius of curvature R.

Specifically, the radius of a circle inscribing the slope and the top face of the substrate part constitutes the radius of curvature R representing the bend of the lid part. The radius of curvature R representing the bend of the lid part shrinks with a rise in transferring speed. Where the transferring speed is fixed, adjustment is made to the radius of curvature R representing the bend determined by that condition.

(Detaching System for Separated Lid Part)

In the present invention, peeling of the lid part 113 is completed in a state in which the sample separated by such a method as electrophoresis, which is kept in the frozen state, is held in the state being adhered on the back surface of the lid part 113. After that, the separated lid part is held, for instance in the above-described second exemplary embodiment, in a state in which an end of the lid part is chucked by a pinch unit, and removed from the top surface of the substrate part by transferring the pinch unit. Further, in the fourth exemplary embodiment through the seventh exemplary embodiment, it is removed from the top surface of the substrate part by being transferred in a state of being held by the system used for peeling. In the third exemplary embodiment, such a mode in which the separated lid part is removed from the top face of the substrate part by separately transferring the pinch unit or units in a state in which its end or ends are held by the pinch unit or units can be employed.

In the present invention, at the step of peeling the lid part 113, the state of adhesion is maintained on the top surface of the sample separated by such a method as electrophoresis, which has come into a frozen state in the groove-shaped channel, and instead peeling off the wall faces of the groove-shaped channel proceeds, with the result that the peeling of the lid part 113 is completed in a state in which the sample separated by such a method as electrophoresis, which is kept in the frozen state, is adhered to the bottom surface of the lid part 113. Therefore, the separated lid part is held and moved away from the top surface of the substrate part, and then the top and bottom surfaces of the lid part are turned over upside down to expose the bottom surface of the lid part upward. As for the turning-over function, for instance, in the second exemplary embodiment, the pinch unit is moved away while keeping the state in which the end of the lid part is chucked by the pinch unit, whereby detaching from the top surface of the substrate part as well as turning over can be accomplished. Further, in the fourth exemplary embodiment, the rotation of the system for peeling is completed while keeping the state in which the lid part is held by the system used for peeling, whereby turning over can be completed, and coincidentally detaching from the top surface of the substrate part can be performed. In the fifth and sixth exemplary embodiments, such a mode in which the holding system is subjected to the turning-over operation while keeping the state in which the end of the lid part is chucked by the vacuum suction unit may be employed. In the third exemplary embodiment, the separated lid part is removed from the top face of the substrate part by separately transferring the pinch unit or units in a state in which its end or ends are held by the pinch unit or units, whereby detaching from the top surface of the substrate part as well as turning over can be accomplished.

(Fractionating System for Sample Separated by Such a Method as Electrophoresis)

In the present invention, the top and bottom surfaces of the lid part are turned over upside down so as to achieve an arrangement in which the sample separated by such a method as electrophoresis in the sustained frozen state, which is adhered to the bottom surface of the lid part, is exposed on the surface, and after that, this sample separated by such a method as electrophoresis in the sustained frozen state can be fractionated into a plurality of fractions along the channel.

Specifically, when the bottom surface of the lid part is bent in a convex shape, the resulted shearing stress along with the bending is loaded on the frozen body of the sample separated by such a method as electrophoresis in the sustained frozen state, which is adhered to the bottom surface of the lid part. In that state, when a sharp blade-shaped jig is brought into contact with the surface of the frozen body to add a slight stress thereto, and thereby the cleavage is initiated just at the site. The operations for cleavage are carried out repeatedly at predetermined intervals, so that the frozen body can be fractionated into a plurality of fractions along the channel. When the fragments of the frozen body are in advance divided by cleavage, the fragments can be split from the bottom surface of the lid part by bending the bottom surface of the lid part in a convex shape of a smaller radius of curvature. Therefore, it is possible to split the individual fragments of the frozen body off from the bottom surface of the lid part by using means mentioned above so as to collect each of the fragments into each of the wells of a fractionation plate (multi-well sample plate) comprising a plurality of wells.

In the present invention, it is also possible to constitute an automatic sample processing apparatus being attached with such a fractionating system.

To add, each of the fragments of the frozen body collected into the wells of the fractionation plate (multi-wells sample plate) by the foregoing distribution operation is subjected to the treatment for re-dissolution to prepare a fractionated sample liquid containing the proteins and the like, which have been separated into the individual fractions. It is also preferable to select a mode in which the system to accomplish the distribution and the subsequent treatment for re-dissolution is combined with the fractionating system to be assembled into the automatic sample processing apparatus.

The operation for the individual step included in the foregoing series of operations can be automated in itself, and further it is also possible to make up the series of operations into a fully automated process by using an automatic operation control system which has a function for automatically executing the operation of each of the systems in accordance with a predetermined process program.

(Analytical Method for Biosamples)

In the analytical method for biosamples according to the present invention, in the case where isoelectric focusing is used as the electrophoretic operation, a plurality of types of proteins contained in the liquid sample to be analyzed can be separated in a state in which they are kept in their natural holding state and maintain their activities. By taking this advantage, it is possible to check regarding each fraction of the sample separated by such a method as electrophoresis whether or not it contains a protein manifesting the targeted activity on the basis of the results of bioassay analysis. For instance, by combining the assay with the biosample analyzing method according to the present invention, it can be utilized as “primary screening” means for checking whether or not a protein component exhibiting the specific activity is contained in the liquid sample to be analyzed and further to identify the molecular weight and the isoelectric point of the target protein component showing the specific activity.

(Apparatus for Microchip Chemical Analysis)

A preferable overall constitution of the apparatus for microchip chemical analysis according to the present invention will be further described.

The apparatus for microchip chemical analysis according to the present invention is applied to handle, in particular, electrophoretically separated fluid samples, in which, as object samples, liquid samples to be analyzed is subjected to the operation for desired separation such as electrophoresis by utilizing the channel formed in the lidded microchip, whereby each of a plurality of substances contained in the liquid samples is positionally separated to form a spot along the channel, but it may also be applied when some other chemical analytical technique than separation by electrophoresis is to be utilized.

In such a case, its overall hardware constitution is set up in such a constitution comprising a chemical analyzing unit 1 for chemically analyzing samples in the channel of the microchip, a solution fixing unit 2 for fixing chemically analyzed samples and electrophoretic liquids, and a lid part separating unit 3 for separating the lid part from the substrate part to collect fixed samples in the channel in the substrate part of the microchip together with the lid part. There is no limitation to other individual members or systems equipped accompanying a structure capable of chemically analyzing samples in the microchip or annexed systems to be employed for applying said samples to analyses at the next and subsequent stages as long as they do not affect analyses by the chemical analyzing unit 1

Chemical analyses to be accomplished by the chemical analyzing unit 1 in the present invention, though not limited in particular, include electrophoretic separation for instance, and isoelectric focusing which allows concentration of the sample at individual isoelectric points is particularly suitable. In this case, the chemical analyzing unit 1 may be composed of an electrode part and a phoretic power source. A voltage is supplied from the phoretic power source to the electrode part via wiring, and the voltage is applied to the electrophoretic liquid in the channel of the microchip by using the electrode part to causes electrophoresis to take place. It is also possible to further arrange a liquid reservoir lid unit over the lid part of the microchip to restrain evaporation of the electrophoretic liquid in the channel. Further, a current monitor for monitoring the current level during applying the voltage may also be provided.

The chemical analyzing unit 1 may further be provided with a transferring system for automatically transferring the liquid reservoir lid unit and/or the electrode part to their predetermined positions. One or a plurality of such accessory systems may be used either independently or in combination.

For the solution fixing unit 2 in the present invention, though there is no particular limitation, used is, for instance, a refrigerating system for fixing by freezing the sample or the electrophoretic liquid chemically analyzed by said chemical analyzing unit 1.

Desirably, the refrigerating system in the present invention may be of a type which refrigerates the substrate part of the microchip by coming into direct contact. There may be only one refrigerating system or a plurality of such systems, which may be supplemented on the system of the substrate part side with a secondary refrigerating system providing refrigeration from the lid part side via the liquid reservoir lid unit. Available ones include but are not limited to, for instance, a refrigerating system using a Peltier device or a chiller.

The lid part separator 3 used in the present invention has a system which attracts by vacuum-chucking, comes into contact with or fixes the lid part, a system which pneumatically attracts, comes into contact with or fixes the substrate part and a transferring system which brings the fixed lid part and the substrate part away from each other.

The system which attracts by vacuum-chucking, comes into contact with or fixes the lid part used in the present invention, though there is no particular limitation, may be a suction unit which causes the lid part to be attracted by vacuum-chucking to the fixing system, an agglutinant unit 12 which agglutinates the lid part to the fixing system, or a lid part fixing unit which brings the lid part into contact with or fixes it to the fixing system.

The system which attracts by vacuum-chucking, comes into contact with or fixes the substrate part used in the present invention, though there is no particular limitation, may be for instance a substrate part sucking unit which causes the substrate part to be attracted by vacuum-chucking to the fixing system, a substrate part agglutinating unit which agglutinates the substrate part to the fixing system, or a substrate part fixing unit which brings the substrate part into contact with or fixes it to the fixing system.

The lid I part vacuum suction unit or the substrate part vacuum suction unit available for use in the present invention has a suction hole and a pressure reducing system which reduces the pressure through the suction hole, and can attract by vacuum-chucking an object approaching the suction hole.

The transferring system used in the present invention, which system brings the fixed lid part and the substrate part away from each other, though there is no particular limitation, may be for instance a chip stage unit which moves up and down the substrate part or the lid part, a roller which turns to wind up the lid part, a pinch unit or a hooking unit which pinches or hooks the lid part or the substrate part, or an opening/closing unit which opens or closes around the shaft as the center of rotation.

The apparatus for microchip chemical analysis of the present invention may further be provided with, as required, a lid part-substrate part joining system which constructs microchips by joining, and a solution injecting system for injecting the sample and/or the electrophoretic liquid into the channel of the microchip. It can also be provided with a signal detection unit for detecting the progress or results of chemical analysis, which is carried out within the microchip.

The lid part-substrate part joining system used in the present invention, though there is no particular limitation, may be for instance a positioning guide such as a projection, dent, hole or pin designed to match the shape of microchips, a holder for holding a microchip, or a transferring system which joins the substrate part and the lid part by arranging them in predetermined positions and pressing the substrate part and the lid part to increase the tightness of adhesion. One or a plurality of such systems may be used either independently or in combination.

The solution injecting system used in the present invention, though there is no particular limitation, may be for instance a pressure reducing system or a pressure applying system which generates a pressure difference between openings positioned at the two ends of the microchip channel, which brings in solution.

The signal detection unit used in the present invention, though there is no particular limitation, may be provided, for instance, with a light-irradiating unit. The signal detection unit has at least a light detector for measuring optical wavelength signals such as absorption wavelengths or fluorescence. For instance, the channel is irradiated with an exciting light from the light-irradiating unit, and the fluorescence is detected by using the light detector. This signal detection unit may be used when analyzing a sample by using the chemical analyzing unit 1 or after the fixation of the solution by using the solution fixing unit 2 post to the analysis.

The apparatus for microchip chemical analysis of the present invention may be constituted by employing one, a plurality of or in combination of the modes so far described.

It is preferable for the apparatus for microchip chemical analysis of the present invention to be further provided with a controlling unit with a view of easy operation. The controlling unit can be used for monitoring the current level by using a current monitoring unit to control the voltage supplied from the power source. Further, the controlling unit can be used for determining the end of chemical analysis based on the current level monitored, the duration of voltage application, and also for controlling the operation of the refrigerating system. Further, the controlling unit can also be used for controlling the operations of the system to attract by vacuum-chucking, bring into contact or fix the lid part, the system to attract by vacuum-chucking, bring into contact or fix the substrate part and the transferring system which parts fixed lid part and the substrate part away from each other, and thereby to expose the channel. Further, the controlling unit can be used for controlling the transferring system which is used in the lid part-substrate part joining system to join the substrate part and the lid part, controlling the pressure reducing system or the pressure applying system which is used in the solution injecting system to generate a different pressure, controlling a heating system or a pressure reducing system which is used in a drying-up system, and for checking the state of sample analysis in the signal detection unit.

The apparatus for microchip chemical analysis according to the present invention may have a constitution further provided with a unit for lid part turning over. The lid part turning-over system is a unit which rotates the lid part separated from the substrate part by using the lid part separator 3 so as to turn over it upside down.

In such a case, in the overall hardware constitution thereof, after chemically analyzing the sample in the channels by using the chemical analyzing unit 1, the electrophoretic liquid and the sample are fixed by using the solution fixing unit 2. The solution fixing unit 2, which is a refrigerating system, freezes and fixes the sample and the electrophoretic liquid. Next, the lid part is separated from the substrate part by using the lid part separating unit 3. After adhering the frozen sample and electrophoretic liquid, which are exposed, to this lid part side, the surface to which the frozen sample and electrophoretic liquid are adhered, which was the bottom surface of the lid part, can be turned upward by using the lid part turning-over unit and held in that direction. It is preferable for the lid part turning-over unit to be refrigerated before it comes into contact with the lid part in order to prevent the frozen sample and electrophoretic liquid adhered to the lid part from being dissolved, when the lid part turning-over unit comes into contact with the lid part.

In this embodiment, for the purpose of adhering the frozen sample and electrophoretic liquid to the lid part side, it is necessary to select the material of the substrate part of the microchip, the structure and surface properties of the channels, the material and surface structure of the lid part, and the composition of the solvent.

In order to stick the frozen sample and electrophoretic liquid to the lid part side, for instance, the friction working between the wall surfaces of the channel and the frozen solution may be reduced to make it easier for the frozen solution to come off the channel. Ways to reduce the friction include using a semicircle or a downward triangle as the sectional shape of the channel. Further, the substrate part may be so structured that the total area of projection over the whole circumference of the wall surfaces of the channel on a plane normal to the top side of the wall surfaces of the channels is not more than a multiple by 0.5 of the surface area over which the lid part comes into contact with the solution in the channels. The total area of projection over the whole circumference of the wall surfaces of the channel on a plane normal to the top side of the wall surfaces of the channel means, in the case where the sides of the wall surfaces of the channel are inclined or normal to the top surface for instance, the area resulting from the integration of the projection area of the wall surfaces of the channel, when the wall surfaces are projected to a plane normal to the top surface of the channel, along the outer circumference of the convex structure. By keeping it no more than 0.5 times the surface area over which the lid part comes into contact with the solution in the channel, the area of contact between the solution in the channel and the wall surfaces of the channel, and consequently the frictional resistance, can be reduced. Alternatively, the frictional resistance between the solution in the channel and the wall surfaces of the channel can as well be made less by reducing the surface energy of the channel surface. In order to reduce the surface energy of the channel surface, smooth-shaped plastic resin, silicone resin, fluorine resin, acryl resin, polypropylene or polyolefin, all low in surface energy, can be used as the material for the substrate part. Furthermore, in the case where the substrate part material whose surface energy is high is used, the surface of the channel may be coated with one of the aforementioned materials lower in surface energy. To stick it to the lid part side, for instance, the lid material may be selected from metals or glass whose surface energy is high, or the lid part surface may have fine roughness to increase the frictional resistance between the lid part surface and the solution.

Next, the apparatus for microchip chemical analysis according to the present invention will be explained with reference to more specific examples. Incidentally, the technical scope of the present invention is not limited to these specific embodiments.

### Eighth Exemplary Embodiment

FIG. 3 is a drawing schematically illustrating an outline of an apparatus to carry out isoelectric separation as an exemplary embodiment of the apparatus for microchip chemical analysis of the present invention. In this eighth exemplary embodiment, a sample is chemically analyzed by isoelectric separation; after fixing the sample and the electrophoretic liquid by freeze fixation, the lid part is separated and the freeze fixed sample and electrophoretic liquid are stuck to the lid part side to expose.

The microchip is composed of the substrate part 103 having a channel structure and the lid part 113 having a hole structure which is to serve as a liquid reservoir.

First, the substrate part 103 is installed on a chip table along a chip guide. The chip table comprises of a Peltier device, a suction hole and a transferring system. The Peltier device is also used as a cooling system for refrigerating the microchip. The suction hole is connected to a vacuum pump, and the substrate part 103 is fixed by vacuum-chucking to the chip table. The transferring system is used as a transferring system for bringing the lid part and the substrate part away from each other. It has also been utilized in the lid part-substrate part joining system.

Next, the lid part 113 is installed on a lid table along a lid guide. The lid table used in this exemplary embodiment is integrated with the lid guide, and also functions as a lid part fixing system.

After that, a liquid reservoir lid unit is attached on the lid part 113. The liquid reservoir lid unit is provided with electrode parts and suction holes in its bottom face, and the electrode parts are arranged in the liquid reservoir part of the lid part 113. The suction holes are used for vacuum-chucking the liquid reservoir lid unit and the lid part 113 by reducing the pressure through the suction hole. The liquid reservoir lid unit is provided with a Peltier device which is used as the cooling system for the lid part when separating the liquid reservoir lid unit and the lid part 113 together. Further, the liquid reservoir lid unit is provided with a transferring system, which is used as a transferring system for transferring the liquid reservoir lid unit to a predetermined position, which has functions as a transferring system for bringing the lid part and the substrate part away from each other, and also is used as a lid part-substrate part joining system.

Next, the chip table, on which the substrate part 103 is installed, is lift up using the transferring system to press the substrate part 103 against the lid part 113, and thereby the microchip is constructed by joining. After that, the position of the chip table is kept as it is. The liquid reservoir lid unit is transferred away from above the lid part 113 to expose the liquid reservoir of the microchip. The electrophoretic liquid, in which the sample is dissolved, is injected into the liquid reservoir of the lid part 113. In particular, to carry out isoelectric focusing, 2% ampholyte (amphoteric carrier) was used as the electrophoretic liquid. When the whole channel of the microchip is filled with the electrophoretic liquid, the electrophoretic liquid remaining in the liquid reservoir is removed. Next, a cathode liquid and an anode liquid are injected into the liquid reservoirs at the two ends of the channel, and the liquid reservoir lid unit is again installed over the lid part 113.

All the transferring systems referred to so far can be operated by using the controlling unit.

A voltage is applied from the power source to the electrode part via wiring, and the current level between the anode and the cathode of the electrode part is measured by using the current monitoring unit. As the current level gradually drops along the duration of applying the voltage, the end of isoelectric separation can be determined if its current level or wattage can be measured.

After the isoelectric separation, the cooling systems for the chip table and the liquid reservoir lid unit are operated to freeze the sample and/or the electrophoretic liquid. Next, while attracting the chip by vacuum-chucking through the suction hole, the substrate part 103 is pressed against the lid part 113 by once raising the chip table, and then the chip table is descended to separate the lid seal part 113 from the substrate part 103. By squeezing the lid part 113 from above and below together with the lid guide, the liquid reservoir lid unit operates as the lid part fixing device. By continuing to refrigerate the substrate part 103 with the refrigerating system for the chip table then, the frozen sample and/or electrophoretic liquid can be exposed over the substrate part 103. At this point of time, the substrate part 103 is positioned underneath the lid part 113. The lid is turned over upside down by using the lid turning-over unit, while the liquid reservoir lid unit keeps in a state in which the lid part 113 is attracted by vacuum-chucking through the suction hole.

In this case, glass was used for the substrate part 103, and the channel width of 100 μm and the channel depth of 10 μm were chosen therein. Silicone resin was used for the lid part 113. In this case, the frozen sample and electrophoretic liquid can be more securely stuck to the lid side by pressing the substrate part 103 against the lid part 113.

Further, in the case when silicone resin is used for the substrate part 103, the channel width of 400 μm and the channel depth of 40 μm are chosen therein, and glass is used for the lid part 113, the frozen sample and electrophoretic liquid can be securely stuck to the lid side 113 without having to press the substrate part 103 against the lid part 113.

As the frozen sample and electrophoretic liquid have the advantage of being solid and therefore easier to handle, it is possible to divide the frozen sample and electrophoretic liquid individually into fractions and transfer them to their predetermined positions for further processing.

### INDUSTRIAL APPLICABILITY

The lidded microchip for analysis, sample processing method using it, automatic sample processing method and automatic sample processing apparatus for lidded microchip for analytical use according to the present invention can be utilized for enhancing the reproducibility of the sample preparation step for further analyses using processed sample having already gone through electrophoretic separation, for instance bioassay and chemical assay analyses.

1. A microchip comprising a substrate part and a lid part, provided with a groove-shaped channel formed in the substrate part, characterized in that:
the sectional shape of the groove-shaped channel formed in the substrate part of the lidded microchip is a trapezoid of which the top side is longer than the bottom side or a rectangle of which the top side and the bottom side are equal; and
when the microchip is cooled to freeze the liquid sample in the channels, the adhesive strength pₜₒₚ per unit channel length of the part (top side), at which a sample which is in a frozen state is in contact with the bottom surface of the lid part (top side), surpasses the adhesive strength p_{bottom} per unit channel length of the parts (bottom side and two flanks), at which the sample is in contact with the wall faces of the substrate part.

2. A method for processing, after subjecting a liquid sample to be analyzed to a desired operation of separating by applying predetermined separating technique with use of a channel formed in the lidded microchip as claimed in claim 1, a separated liquid sample held in the channel formed in the lidded microchip, characterized in that:
said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,
after completing the desired operation of separation of the liquid sample to be analyzed by utilizing the channel formed in the lidded microchip, the method comprises the following steps:
a step of refrigerating in which the separated liquid sample held in the channel is subjected to an operation to freeze the aqueous solvent that is contained therein by refrigerating the substrate part of said lidded microchip to achieve a predetermined low-temperature condition at or below the ice point;
a step of peeling the lid part step off in which, for the purpose of causing the sample to come off from the groove-shaped channel in the state of adhering to the bottom surface of the lid part while maintaining the separated sample in a sustained frozen state by keeping the substrate part of said lidded microchip refrigerated at said predetermined low temperature,
an operation for peeling and removal of the lid part off the substrate part is carried out by applying an external force to an end of the lid part to peel the bottom surface of the lid part off the top surface of the substrate part, in order to perform an operation to release the adhesive strength which has brought the top surface of the substrate part and the bottom surface of the lid part in tight contact with each other and achieved an adhered state in a predetermined arrangement, while maintaining a condition relative to a predetermined threshold R_{eq2} that the radius of curvature R manifested by the local bending of the lid part on the interface where the peeling is proceeding is greater than said threshold R_{eq2} (R>R_{eq2}); and
a step of detaching the lid part in which, after the end of said peeling off step, an operation for transferring and turning over is carried out in such a manner that the lid part separated by releasing from the adhesion and fixation to the top surface of the substrate part is transferred away from the top surface of the substrate part, while maintaining a state in which said separated sample is sustained in the frozen state and kept in the state of adhering to the bottom surface of the lid part, and then the top surface and the bottom surface of the lid part are turned over upside down, and the separated lid part is held in an arrangement in which the separated sample adhering to the bottom surface of the lid part in the sustained frozen state is exposed on the surface thereof;
wherein the series of these steps are sequentially performed.

3. A method for automatically processing, after subjecting a liquid sample to be analyzed to a desired operation of separating by applying a predetermined separating technique with use of a channel formed in the lidded microchip as claimed in claim 1, a separated liquid sample held in the channel formed in the lidded microchip, characterized in that:
said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,
after completing the desired operation of separation of the liquid sample to be analyzed by utilizing the channel formed in the lidded microchip, the method comprises the following steps:
a step of refrigerating in which the separated liquid sample held in the channel is subjected to an operation to freeze the aqueous solvent that is contained therein by refrigerating the substrate part of said lidded microchip to achieve a predetermined low-temperature condition at or below the ice point;
a step of peeling the lid part step off in which, for the purpose of causing the sample to come off from the groove-shaped channel in the state of adhering to the bottom surface of the lid part while maintaining the separated sample in a sustained frozen state by keeping the substrate part of said lidded microchip refrigerated at said predetermined low temperature,
an operation for peeling and removal of the lid part off the substrate part is carried out by applying an external force to an end of the lid part to peel the bottom surface of the lid part off the top surface of the substrate part, in order to perform an operation to release the adhesive strength which has brought the top surface of the substrate part and the bottom surface of the lid part in tight contact with each other and achieved an adhered state in a predetermined arrangement, while maintaining a condition relative to a predetermined threshold R_{eq2} that the radius of curvature R manifested by the local bending of the lid part on the interface where the peeling is proceeding is greater than said threshold R_{eq2} (R>R_{eq2}); and
a step of detaching the lid part in which, after the end of said peeling off step, an operation for transferring and turning over is carried out in such a manner that the lid part separated by releasing from the adhesion and fixation to the top surface of the substrate part is transferred away from the top surface of the substrate part, while maintaining a state in which said separated sample is sustained in the frozen state and kept in the state of adhering to the bottom surface of the lid part, and then the top surface and the bottom surface of the lid part are turned over upside down, and the separated lid part is held in an arrangement in which the separated sample adhering to the bottom surface of the lid part in the sustained frozen state is exposed on the surface thereof;
wherein the series of these steps are automatically performed.

4. An apparatus for automatically processing, after subjecting a liquid sample to be analyzed to a desired operation of separating by applying predetermined separating technique with use of a channel formed in the lidded microchip as claimed in claim 1, a separated liquid sample held in the channel formed in the lidded microchip, characterized in that:
said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,
the apparatus comprises the following systems to be provided for the lidded microchip in which the desired operation of the separation of the liquid sample to be analyzed has been completed by utilizing the channel formed in the lidded microchip:
a system for refrigerating the substrate part, which system is adapted for installation in an arrangement in contact with the substrate part of said lidded microchip;
a control unit for the refrigerating system, which unit is capable of maintaining at least the substrate part in a predetermined low-temperature condition at or below the ice point with refrigeration by the substrate part refrigerating system to be installed in the arrangement in contact with the substrate part;
a system for fixing the substrate part, which system is capable of fixing the substrate part of said lidded microchip in the arrangement in contact with said substrate part refrigerating system;
a system for applying an external force, which system has a function to apply to an end of the lid part an external force having a component in a direction substantially normal to the top surface of the substrate part to release the adhesive strength which has brought the top surface of the substrate part and the bottom surface of the lid part into tight contact with each other and thereby achieved an adhesion state in a predetermined arrangement;
a system for transferring the end of the lid part, which system is capable of transferring the end of the lid part in a direction substantially normal to the interface of contact between the top surface of the substrate part and the bottom surface of the lid part in synchronism with the external force application to the end of the lid part by said external force applying system;
a system for controlling a speed of transferring the end of the lid part, which system has a function to control the transfer speed of the end of the lid part so that, in the process of peeling the bottom surface of the lid part off the top surface of the substrate part by using the external force applying system and the lid part end transferring system, which systems works in synchronism on the end of said lid part, the radius of curvature R manifested by the local bending of the lid part on the interface where the peeling is proceeding is maintained in such a condition that, relative to a predetermined threshold R_{eq2}, the radius of curvature R is greater than said threshold R_{eq2} (R>R_{eq2});
a system for detaching the separated lid part, which system has a function that, after the operation to peel the lid part off the top surface of the substrate part is ended, the system holds the lid part which is separated from the top surface of the substrate part by releasing the adhesive fixation, transfers it away from the top surface of the substrate part, and then turns over the top surface and the bottom surface of the lid part upside down, so as to expose the bottom surface of the lid part upward; and
the apparatus further comprises a system for controlling an automatic operation thereof, which has a function to cause the actions of each of the systems accomplishing the series of operations set forth to be to be automatically accomplished in accordance with a predetermined process program.

5. A method for analyzing bio-sample, which is a method in which, after subjecting a liquid sample to be analyzed to a desired operation of electrophoretic separation by applying a predetermined electrophoretic technique by utilizing the channel formed in the lidded microchip as claimed in claim 1, out of the electrophoretically separated liquid sample held in the channels formed in the lidded microchip, ingredient substances spot-separated on said channel are fractionated into a plurality of fractions along the channel, and then bioassay analysis of the spot-separated ingredient substances contained in the fractions is performed, characterized in that:
said lidded microchip has a constitution in which the groove-shaped channel formed in the substrate part thereof and the lid part sealing the top surface of the substrate part have achieved a state of being adhered together in a predetermined arrangement so that the top surface of the substrate part and the bottom surface of the lid part are tightly adhered to each other,
the method comprising:
a step of collection, in which, after completing the desired operation of electrophoretic separation of the liquid sample to be analyzed by utilizing the channel formed in the lidded microchip,
the lid part, with which the top surface of the substrate part is tightly covered by sealing, is peeled and removed out in accordance with the method for automatic sample processing for the lidded microchip for analytical use as claimed in claim 3, and then
the electrophoretically separated sample, which is kept in a sustained frozen state, is collected by isolating the sample out of the groove-shaped channel formed in the substrate part while maintaining it in a state of adhering to the bottom surface of the lid part;
a step for fractionating, in which the electrophoretically separated sample maintained in a sustained frozen state is fractionated into a plurality of fractions along said channel, and
ingredient substances separated as spot points in the groove-shaped channel formed in the substrate part are caused to be contained in any one of said plurality of fractions;
a step for treatment of fraction re-dissolution, in which each of sample fragments in the frozen state, which is contained in any one of the plurality of fractions that are corresponding to part of said electrophoretically separated sample, is subjected to re-dissolution treatment respectively to prepare each of fractionated sample liquids;
a step of specifying the range of each fraction, regarding each of the plurality of fractions which are divided along the groove-shaped channel formed in the substrate part, identification of electrophoretic index values corresponding to the two ends of the fraction is made on the basis of information on the positions of the two ends of the fraction on the channel;
a step for bioassay analyzing the fraction, in which each of fractionated sample liquids is subjected to the bioassay analysis to determine whether or not any ingredient substance showing the specific properties that can be identified by the bioassay analysis is contained in the fraction; and
a step for analyzing data, in which it is determined on the basis of the result of the bioassay analysis of the fraction whether or not the 50 ingredient substance exhibiting the specific properties that are identifiable by said bioassay analysis is separated as a spot point in the range of the fraction in question, and
information on the range of electrophoretic index values that identify the range of each fraction, in which on the basis of which it is determined that the ingredient substance exhibiting the specific properties that are identifiable by said bioassay analysis is determined to be separated as a spot point is acquired along the groove-shaped channel.

6. The method according to claim 3, wherein the operation of separating by applying the predetermined separating technique is isoelectric focusing.

7. The method according to claim 4, wherein the operation of separating by applying the predetermined separating technique is isoelectric focusing.

8. The method according to claim 5, wherein the operation of separating by applying the predetermined separating technique is isoelectric focusing.

9. An automatic sample processing method characterized in that:
after the step for detaching the lid part is completed in accordance with the automatic sample processing method for the lidded microchip for analytical use according to claim 3,
the method further comprises:
a step for fractionating, in which the sample separated by applying the predetermined separating technique, which sample is kept in a sustained frozen state, is collected by isolating the sample out of the groove-shaped channel formed in the substrate part while maintaining it in a state of adhering to the bottom surface of the lid part, and then the separated sample is fractionated into a plurality of fractions along said channel,
whereby ingredient substances separated as spot points in the groove-shaped channel formed in the substrate part are caused to be contained in any one of said plurality of fractions; and
a step for treatment of fraction re-dissolution, in which each of sample fragments in the frozen state, which is contained in any one of the plurality of fractions that are corresponding to part of said separated sample, is subjected to re-dissolution treatment respectively to prepare each of fractionated sample liquids.

10. An automatic sample processing apparatus characterized in that:
in addition to the systems of the automatic sample processing apparatus for the lidded microchip for analytical use as claimed in claim 4,
the apparatus further comprises:
a system for fractionating, which has a function for cutting the sample in a sustained frozen state into fragments, in which, regarding the sample separated by applying the predetermined separating technique, which sample being kept in a sustained frozen state, is collected by isolating the sample out of the groove-shaped channel formed in the substrate part while maintaining it in a state of adhering to the bottom surface of the lid part, the separated sample is fractionated into a plurality of fractions belong said channel to prepare a plurality of sample fragments in a sustained frozen state, and
a system for treatment of fraction re-dissolution, which has a function for distribution and a function for thermal re-dissolving, in which each of the plurality of sample fragments in a sustained frozen state, which are prepared by fractionating the separated sample by using said system for fractionating, is distributed to each well of multi-well sample plate, and then each of the sample fragment is subjected to re-dissolution treatment to prepare each of fractionated sample liquids.

11. The method according to claim 9, wherein the operation of separating by applying the predetermined separating technique is isoelectric focusing.

12. The apparatus according to claim 10 wherein the operation of separating by applying the predetermined separating technique is isoelectric focusing.
